(19) United States
(12) Patent Application Publication
(10) Pub. No.: US 2016/0379308 A1
(43) Pub. Date: Dec. 29, 2016

(54) SYSTEM AND METHOD FOR NON-SUBJECTIVELY DETERMINING INSURANCE TO ASSET GAP WITH NON-NUMERIC GRAPHICAL DISPLAY OF THE DETERMINED GAP

(71) Applicant: Vicmar71,LLC, Billings, MT (US)

(72) Inventor: Marcus A. THURSTON, Billings, MT (US)

(73) Assignee: Vicmar71,LLC, Billings, MT (US)

(21) Appl. No.: 15/176,020

(22) Filed: Jun. 7, 2016

Related U.S. Application Data
(60) Provisional application No. 62/183,648, filed on Jun. 23, 2015.

(51) Int. Cl. G06Q 40/08

(52) U.S. Cl. CPC G06Q 40/08

(57) ABSTRACT

Provided is a system and method to determine without third-Party subjectivity, and visually indicate with a non-numeric graphic a gap in insurance coverage for a Party. This system and method operating to receive from a Party a plurality of information items including, Party specific information, an indication of Risk Tolerance, an Insurance Inventory and an Asset Inventory; process the received information items to determine Future Income for the Party and an initial gap value between total initial insurance value and total initial asset value, and develop a non-numeric graphic representing Risk Tolerance. The system and method further continuing to develop non-numeric graphics conceptualizing the Party's Risk Tolerance and gap in insurance coverage and to permit the Party to select one or more solution options of different insurance types and amounts, and render at least one non-numeric graphic conceptualizing the Party's solution for insurance coverage for visual comparison with the Party's gap in insurance coverage, the initial gap and the solution determined directly from information provided by the user and without third-Party subjectivity.

### CROSS REFERENCE TO RELATED APPLICATIONS

This application claims the benefit under 35 U.S.C. §119(e) of U.S. Provisional Application No. 62/183,648 filed Jun. 23, 2015 and entitled SYSTEM AND METHOD FOR NON-SUBJECTIVELY DETERMINING INSURANCE TO ASSET GAP WITH NON-NUMERIC GRAPHICAL DISPLAY OF THE DETERMINED GAP, the disclosure of which is incorporated herein by reference.

### FIELD OF THE INVENTION

The present invention relates generally to systems and methods for non-subjectively determining insurance to asset gap with non-numeric graphical display of the determined gap.

### BACKGROUND

In the modern world, the majority of individuals are engaged in professional activities so as to build a lifestyle, provide for their families and enjoy retirement. As simple as this one statement may seem, it is actually a very complex endeavor to achieve.

As we as individuals interact with others intentionally and unintentionally, there is often a possibility of liability to others as to ourselves. Moreover, in the quest to establish a lifestyle that affords at least the basics—shelter, clothing, food, and some element of familial fun and enjoyment, monetary budgets are an important element. While people do save and plan, the majority of people are not in a position to cover the costs of an auto accident or home damage caused by fire, flood or other disaster.

Indeed in many instances what are considered to be a persons' assets and investments towards the future are potentially at risk. To mitigate this risk, it has become commonplace for individuals to purchase one or more types of insurance. Indeed, there are now many different types of insurance—car insurance, home insurance, life insurance, health insurance, property insurance, collectables insurance, specialty insurance, disability insurance, etc . . . just to name a few.

Fundamentally, the idea of insurance is to shift the risk of loss from an individual to an insurance company. Clearly insurance companies exist to be profitable and are quite astute at determining the statistical odds for a claim on a particular type of insurance and/or the amount of insurance. Indeed these calculations are informative in the differences in cost of insuring a $500,000.00 home in California where earthquakes may be a factor and tornados are not, and the same home in a tornado fraught area of Oklahoma. Likewise there are differences that drive the costs of auto insurance for different people with different cars in different areas.

Life insurance and disability insurance also have different driving factors in rate determination, and while it is easy to understand that earning a gainful living is highly desirable and important to long term goals, it can often be very difficult for a person to understand how much insurance to have and/or which type of insurance is most suitable for them.

Indeed, in most cases insurance is looked upon as a worst case issue that most hope to avoid having to utilize. It has therefore become somewhat commonplace to look merely at the lowest cost as the most important factor and coverage as secondary—a “name your comfort price” market. While perhaps desirable with the short term view where a person does not expect to use insurance, this approach can be disastrous if a problem occurs and a claim is made that far exceeds the provided coverage.

Indeed this is a fundamental problem. So long as insurance is not required, life of the individual may indeed be fine. But all too often, this is actually a condition of being under insured. A state of being under insured is when and where a claim may arise that cannot be met by the liabilities of the current insurance. In such a case of under insurance, the remaining balance of liability is typically burdened upon the individual directly, and this burden is typically covered by his or her assets, most typically his or her retirement savings and/or physical assets. When a claim of liability occurs and a state of being under insured is fully realized, it is often a condition that is life altering.

A review and understanding of insurance is therefore important, but sadly it is often a task that is shunned or avoided for fear of expense in being told that yet more insurance is necessary. In addition, most individuals are not versed in insurance terms tables and actuarial calculations. As such, understanding insurance options can be a daunting task, made even more so by the realization and/or perception that insurance agents are often paid based on the type of insurance sold.

With statistical charts and graphs depicting information for, “why this is the policy for you,” an individual is very likely feel overwhelmed with information that he or she does not understand. The basic premise that Insurance is and should be used to protect property, money and financial future becomes a blurred goal as one may feel they are being lead along a review process that is not really under their control.

Various attempts have been made and are known to review insurance and assist with financial planning. However, those systems and methods that are known to exist appear to continue with tools that are well known to the insurance brokers, i.e. statistical charts full of numbers and fine detail, and are subjectively based to identify solutions for the customer, i.e. the customer is directed towards a product and does not feel that he or she is in control of the analysis process.

For example, US Application 2015/0006206 to Mideway teaches what is intended as a Consumer-Centered Risk Analysis and Insurance Purchasing Systems and Method. Utilizing an interview and analysis engine, Mideway attempts to present potential insurance customers with a defined set of questions, the answers to which lead to yet other defined questions in an effort to identify and analyze risk and propose a solution. Moreover the interview and analysis engine, though perhaps helpful, has been established subjectively to lead or direct the user to or away from particular products. Answer A may lead to Question B with that answer leading to product C, but Answer D leading to Question B′ may lead to other questions which ultimately lead back to product C. Moreover, the interview and analysis engine has been subjectively established to determine for and present to a customer one or more solution options. As Mideway operates, graphs and information regarding risk and possible policies are clearly displayed in traditional forms as tables and charts.

U.S. Pat. No. 8,515,788 to Tracy, discloses a Method and System for Providing Customized Risk Mitigation/Recovery To An Insurance Customer. More specifically, a computer system is configured to gather data from a customer's computer system and to process the customer information data so as to identify at least one peril associated with the customer information data. With such a peril identified the customer information data is used to generate a plurality of risk mitigation options based on the one or more perils. Here too what constitutes a peril is a predefined subjective condition and the plausible solutions are determined for and presented to the customer.

U.S. Pat. No. 6,684,190 to Powers, discloses an Apparatus and Method For Exposing, Evaluating, And Rebalancing Risk for Decision-Making Financial Planning. More specifically, Powers is a computer apparatus and method for exposing risk inherent in various financial planning areas such as retirement, insurance, estate decision-making and targeted financial goal funding. This risk can be rebalanced based on the customer's risk tolerance, and is accomplished through the dynamic use of detailed charts and displays perhaps typical to those in the financial industry, but with the detailed information potentially overwhelming a customer. And again there is a subjective component imposed on the client in determining what the future financial plan is and how it should be accomplished.

Moreover, current systems to forecast future long term care, determine future risk to assets and gaps in insurance coverage, although potentially helpful, appear to succumb to at least two shortcomings. The first is that how the information is gathered and presented back to the customer is in a very complex fashion that is not intuitive or well understood by a layperson. Complex charts and tables may indeed provide a wealth of detailed information to those who understand them, but that detail is often intimidating as it is not easily understood by those not familiar with such charts and tables. All too often, the layperson is the party who may or may need assistance in understanding where he or she stands with respect to their possible needs and current level of insurance.

The second is that the process of gathering this information and presenting it back is often highly subjective to the customer—“this is who you are, . . . and this is what you need.” The customer often has the feeling that after answering a series of questions a product or plan is returned as “the solution”—but how this product or plan really serves them or is truly related to the information they have provided is mysterious. Moreover, it is not uncommon for a review to be performed and a product to be suggested which is later learned to have a high commission to the broker—leading the customer to wonder if the product is truly the best for them, or best for the agent.

Hence there is a need for a method and system that is capable of overcoming one or more of the above identified challenges.

### SUMMARY OF THE INVENTION

Our invention solves the problems of the prior art by providing novel systems and methods for non-subjectively determining insurance to asset gap with non-numeric graphical display of the determined gap.

In particular, and by way of example only, according to one embodiment of the present invention, provided is a computer system having at least one physical processor and memory adapted by software instructions to determine without third-Party subjectivity, and visually indicate with a non-numeric graphic a gap in insurance coverage for a Party, including: a Party Initializer module that collects from a Party, Party specific information, including, name, age, address and annual income; a Risk Module that presents the Party with a first set of questions to collect information regarding Risk Evaluation and a second set of questions regarding Risk Tolerance, each question having a pre-determined set of optional answers each correlating to a different point value, the Risk Module determining a cumulative point value for the Party's indicated Risk Tolerance; an Insurance Inventory Module permitting the Party to provide information regarding the nature and an amount of coverage for each type of insurance held by the Party; an Asset Inventory Module permitting the Party to provide information regarding a nature and a value amount for each Asset provided in the Asset Inventory, the Asset Inventory further including a calculation of future income from the Party specific information of age and annual income; a Processing module for comparative processing of the Insurance Inventory with the Asset Inventory to determine an initial gap value between the Party's initial insurance value and initial asset value; the Processing module further operating to receive a solution option for an additional type and amount of insurance selected by the Party and to determine a solution value; a Visualizer module for transforming the Party's Risk Tolerance, the gap value between the Party's initial insurance value and initial asset value, and the solution for insurance coverage into non-numeric graphics conceptualizing at least the Party's Risk Tolerance, the gap value between the Party's initial insurance value and initial asset value, and the solution for insurance coverage; a database structured and arranged to record for each assessed Party, the Party specific information, Risk Evaluation answers, Risk Tolerance answers, Insurance Inventory, Asset Inventory, and determined gap valuations and solutions.

In yet another embodiment, provided is a method to determine without third-Party subjectivity, and visually indicate with a non-numeric graphic, a gap in insurance coverage for a Party, including: receiving from the Party, Party specific information including, name, age, address and annual income; presenting a set of Risk Evaluation questions to the Party and recording each Risk Evaluation answer as provided by the Party; presenting a set of Risk Tolerance questions to the Party, each Risk Tolerance question providing a pre-defined set of answers, each answer corresponding to a pre-determined numeric value; recording each Risk Tolerance answer and tallying the assigned values of each answer, and based on the aggregate value rendering an initial non-numeric graphic conceptualizing the Party's indicated risk level; receiving from the Party an Insurance Inventory, including nature and an amount of coverage for each type of Insurance provided in the Insurance Inventory; receiving from the Party an Asset Inventory, including a nature and a value amount for each Asset provided in the Asset Inventory, the Asset Inventory further including a calculation of future income from the Party specific information of age and annual income; processing the Insurance Inventory and the Asset Inventory to determine an initial gap value between total initial insurance value and total initial asset value, and based on the initial gap valuation rendering at least one non-numeric graphic conceptualizing the Party's gap in insurance coverage; and permitting the Party to select one or more solution options of different insurance types and amounts, and rendering at least one non-numeric graphic conceptualizing the Party's solution for insurance coverage for visual comparison with the Party's gap in insurance coverage, the initial gap and the solution determined directly from information provided by the Party and without third-Party subjectivity.

For another embodiment, provided is a non-transitory machine readable medium on which is stored a computer program for determining without third-Party subjectivity, and visually indicate with a non-numeric graphic a gap in insurance coverage for a Party, the computer program comprising instructions which when executed by a computer system having at least one processor performs the steps of: receiving from the Party, Party specific information including, name, age, address and annual income; presenting a set of Risk Evaluation questions to the Party and recording each Risk Evaluation answer as provided by the Party; presenting a set of Risk Tolerance questions to the Party, each Risk Tolerance question providing a pre-defined set of answers, each answer corresponding to a pre-determined numeric value; recording each Risk Tolerance answer and tallying the assigned values of each answer, and based on the aggregate value rendering an initial non-numeric graphic conceptualizing the Party's indicated risk level; receiving from the Party an Insurance Inventory, including nature and an amount of coverage for each type of Insurance provided in the Insurance Inventory; receiving from the Party an Asset Inventory, including a nature and a value amount for each Asset provided in the Asset Inventory, the Asset Inventory further including a calculation of future income from the Party specific information of age and annual income; processing the Insurance Inventory and the Asset Inventory to determine an initial gap valuation between total initial insurance value and total initial asset value, and based on the initial gap valuation rendering at least one non-numeric graphic conceptualizing the Party's gap in insurance coverage; and permitting the Party to select one or more solution options of different insurance types and amounts, and rendering at least one non-numeric graphic conceptualizing the Party's solution for insurance coverage for visual comparison with the Party's gap in insurance coverage, the initial gap and the solution determined directly from information provided by the user and without third-Party subjectivity.

Further, in yet another embodiment provided is a method to determine without third-Party subjectivity, and visually indicate with a non-numeric graphic a gap in insurance coverage for a Party, including: receiving from a Party a plurality of information items including, Party specific information, an indication of Risk Tolerance, an Insurance Inventory and an Asset Inventory; processing the received information items to determine Future Income for the Party and an initial gap value between total initial insurance value and total initial asset value, develop a non-numeric graphic representing Risk Tolerance; developing non-numeric graphics conceptualizing the Party's Risk Tolerance and gap in insurance coverage; permitting the Party to select one or more solution options of different insurance types and amounts, and rendering at least one non-numeric graphic conceptualizing the Party's solution for insurance coverage for visual comparison with the Party's gap in insurance coverage, the initial gap and the solution determined directly from information provided by the user and without third-Party subjectivity.

### BRIEF DESCRIPTION OF THE DRAWINGS

FIG. 1 illustrates a high level diagram of a Gap Determination and Solution System “GDSS” without third party subjectivity in accordance with at least one embodiment;

FIG. 2 is a high level flow diagram for a method of non-subjectively determining insurance to asset gap with non-numeric graphical display of the determined gap in accordance with at least one embodiment;

FIG. 3 is a conceptual screen shot of the application window for the Client Contact Page as initially blank, in accordance with at least one embodiment;

FIG. 4 is a conceptual screen shot of the application window for the Client Contact Page now completed, in accordance with at least one embodiment;

FIG. 5 is a conceptual screen shot of the application window for the Risk Evaluation Page in accordance with at least one embodiment;

FIG. 6 is a conceptual screen shot of the application window for the Risk Tolerance Page in accordance with at least one embodiment;

FIG. 7 is a conceptual screen shot of the application window for the Insurance Inventory Page as initially blank in accordance with at least one embodiment;

FIG. 8 is a conceptual screen shot of the application window for the Insurance Inventory Page, Auto subsection now completed in accordance with at least one embodiment;

FIG. 9 is a conceptual screen shot of the application window for the Insurance Inventory Page, Specialty subsection now completed in accordance with at least one embodiment;

FIG. 10 is a conceptual screen shot of the application window for the Insurance Inventory Page, Home subsection now completed in accordance with at least one embodiment;

FIG. 11 is a conceptual screen shot of the application window for the Insurance Inventory Page, Collectables subsection now completed in accordance with at least one embodiment;

FIG. 12 is a conceptual screen shot of the application window for the Insurance Inventory Page, Umbrella subsection now completed in accordance with at least one embodiment;

FIG. 13 is a conceptual screen shot of the application window for the Insurance Inventory Page, Life subsection now completed in accordance with at least one embodiment;

FIG. 14 is a conceptual screen shot of the application window for the Insurance Inventory Page, Disability subsection now completed in accordance with at least one embodiment;

FIG. 15 is a conceptual screen shot of the application window for the Asset Inventory Page as initially blank in accordance with at least one embodiment;

FIG. 16 is a conceptual screen shot of the application window for the Asset Inventory Page now completed blank in accordance with at least one embodiment;

FIG. 17 is a conceptual screen shot of the Gap Results page for Auto and Home Gap elements without a solution in accordance with at least one embodiment;

FIG. 18 is a conceptual screen shot of the Gap Results page for Auto and Home Gap elements with the Solution of Umbrella Insurance in accordance with at least one embodiment;

FIG. 19 is a conceptual screen shot of the Gap Results page for Lifestyle elements with the Solution of Umbrella Insurance in accordance with at least one embodiment;

FIG. 20 is a conceptual screen shot of the Gap Results page for Assets Gap with the Solution of Umbrella Insurance in accordance with at least one embodiment;

FIG. 21 is a high level flow diagram for a method of non-subjectively determining insurance to asset gap with non-numeric graphical display of the determined gap in an Agency setting in accordance with at least one embodiment; and

FIG. 22 is a high level block diagram of a computer system in accordance with at least one embodiment.

### DETAILED DESCRIPTION

Before proceeding with the detailed description, it is to be appreciated that the present teaching is by way of example only, not by limitation. The concepts herein are not limited to use or application with a specific system or method for non-subjectively determining insurance to asset gap with non-numeric graphical display of the determined gap. Thus although the instrumentalities described herein are for the convenience of explanation shown and described with respect to exemplary embodiments, it will be understood and appreciated that the principles herein may be applied equally in other types of systems and methods for non-subjectively determining insurance to asset gap with non-numeric graphical display of the determined gap.

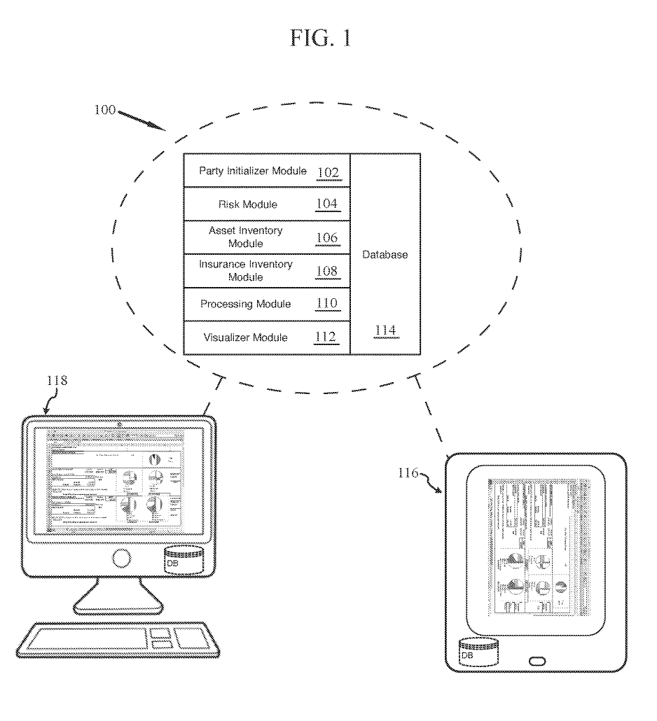

This invention is described with respect to preferred embodiments in the following description with reference to the Figures, in which like numbers represent the same or similar elements. Further, with the respect to the numbering of the same or similar elements, it will be appreciated that the leading values identify the Figure in which the element is first identified and described, e.g., element 100 appears in FIG. 1.

Various embodiments presented herein are descriptive of apparatus, systems, articles of manufacturer, or the like for customer driven determination without third-party subjectivity of the customer's insurance to asset gap. In some embodiments, an interface, application “dashboard” or application “window” may be provided that allows the customer or person assisting the customer to enter, assess, review and adjust data to process and/or analyze the customers valuation of risk, collection of assets and insurance inventory.

Moreover, some portions of the detailed description that follows are presented in terms of the manipulation and processing of data bits within a computer memory. The steps involved with such manipulation are those requiring the manipulation of physical quantities. Generally, though not necessarily, these quantities take the form of electrical or magnetic signals capable of being stored, transferred, combined, compared and otherwise manipulated. Those skilled in the art will appreciate that these signals are commonly referred to as bits, values, elements number or other identifiable elements.

It is of course understood and appreciated that all of these terms are associated with appropriate physical quantities and are merely convenient labels applied to these physical quantifies. Moreover, it is appreciated that throughout the following description, the use of terms such as “processing” or “evaluating” or “receiving” or “outputting” or the like, refer to the action and processor of a computer system or similar electronic computing device that manipulates and transforms data represented as physical (electrical) quantities within the computer system's memories into other data similarly represented as physical quantities within the computer system's memories.

The present invention also relates to apparatus for performing the operations herein described. This apparatus may be specifically constructed for the required purposes as are further described below, or the apparatus may be a general purpose computer selectively adapted or reconfigured by one or more computer programs stored in the computer upon computer readable storage medium suitable for storing electronic instructions.

To further assist in the following description, the following defined terms are provided. “Customer” or “Party”—as used herein is understood and appreciated to generally refer to any entity for which a determination of insurance to asset gap with non-numeric graphical display is performed. More specifically, while for at least one embodiment of the present invention is intended for insurance to asset gap assessment for people as individuals, couples or households, other embodiments of the present invention may be applied to legal entities such as businesses, companies, corporations, States, and/or other such organizations. Moreover, a customer may be an insurance policy holder or even an entity that seeks to review and determine asset to insurance gap for an insurance policy holder.

“Risk Evaluation”—as used herein is understood and appreciated to be a numerical, qualitative and quantitative valuation of the Party's assessed acceptance between benefits and associated risks with respect to future financial security.

“Risk Tolerance”—as used herein is understood and appreciated to be a numerical, quantitative valuation of a Party's willingness to accept risk, and specifically financial risk. A Party should have a realistic understanding of his or her ability and willingness to bare large swings in the value of his, her or their collective investments. It is not uncommon for a Party to express themselves as being Risk Tolerant, but through a systematic Risk Evaluation process to actually find that they are much more risk averse then perhaps they were consciously aware.

“Asset Inventory”—as used herein is understood and appreciated to be an inventory of the Party's financial assets, such as but not limited to bank accounts, investments, personal property, real estate, future income, and or other assets having a financial value potentially significant to current and future self worth of the Party.

“Insurance Inventory”—as used herein is understood and appreciated to be an inventory of the Party's insurance coverage, such as but not limited to home, auto, personal, life, umbrella, disability, specialty or other insurance that is currently in place with respect to one or more of the Party's Assets.

“Gap”—as used herein is understood and appreciated to be the determined “gap” in coverage between the Party's Assets, as determined from the Asset Inventory, and Insurance coverage as determined by the Insurance Inventory.

“Solution”—as used herein is understood and appreciated to be one or more insurance options that may be selected by the Party in response to the system determined Gap. Moreover, for at least one embodiment the Party may try different types of Solutions in substantially real time so as to explore and understand directly how various different types of Solution options relate to the determined Gap as a complete or partial bridge for the determined Gap.

“Non-Numeric Graphic”—as used herein is understood and appreciated to be a visual graphic presented by a graphical user interface, aka GUI, of the present invention which are predicated on fundamental principles of bigger and smaller elements which may also incorporate color indicators such as Green or Blue for Good and Red or Yellow for Caution or Concern. Moreover, the Non-Numeric Graphics are presentations of information that are quickly and easily understood without the need or requirement for a legend or key—they are graphically displayed data without reliance on numerical indicators. Moreover, the Party is allowed to evaluate and compare data elements as greater than, less than, equal, good and/or bad based simply on a visual comparison of how the elements are presented. It is expressly understood and contemplated that a “Non-Numeric” Graphic, Scale or Indicator may be expressed as one or more of a variety of graphical representations, including, but not limited to, a pie-chart, bar graph, gage meter. It is generally understood that any visual representation that permits the comparison of at least two elements to each other based on similar size, scale or distance between two end points defining a minimum and a maximum may be used. In addition, numbers may be present with the non-numeric graphic, but it is key to understand that meaning of the non-numeric graphic can be understood and appreciated without reliance upon any displayed number(s). The Non-Numeric Graphic elements of the present invention are displayed and manipulated during the runtime process.

“Third-Party Subjectivity”—is understood and appreciated to be the will, ideas and opinions of a person. Insurance in a financial form is generally accepted as a “necessary evil” but can also be viewed very skeptically by the purchaser as to whether the policy offered is in the best interest of the buying party or offered because of financial motivation to the selling agent, i.e., “this is the policy for you” is a statement based heavily on third-party subjectivity as held by the agent. Good intentions or bad cannot be easily weighted or understood by the buying Party. However, as a buying Party is not typically also an insurance agent or otherwise familiar with financial terms and structures, Third-Party Subjectivity is often itself accepted as a necessary, though undesirable, risk in the insurance review or acquisition process.

As the following description and accompanying drawings will support, the present invention advantageously achieves systems and methods to determine without third party subjectivity, and visually indicate with a non-numeric graphic, a gap (if present) in in insurance coverage for a party. More specifically, embodiments of the present invention permit the Party to drive the process—he or she providing information and he or she can see in near real time how that information reveals the state of any gap between assets and insurance, and how solution options of different types may be applied with differing results. For an instance where the Party has sufficient insurance such that no Gap exists, the present invention will clearly indicate this as well.

Further, in a stark departure from traditional systems and methods for reviewing insurance and financial planning, the present invention advantageously provides results as non-numerical graphics—items which are easy to understand at a glance, and which therefore avoid potential issues of intimidation or over reliance on the assessment from another person. In addition, colors have been used to quickly and easily further heighten the understanding of these non-numerical graphs. Moreover, numeric data pertaining to a Party and his or her coverage is transformed into visual charts conveying essential concepts—good/bad, large/small, Area A/Area B. The adage of a picture being worth a thousand words is applicable to numbers too—detailed information is necessary for a viable assessment, but the transformation of that information from the unfamiliar (i.e., numeric charts and graphs) to the familiar (bars, pies, greens and reds, etc . . . ) provides the Party with an assessment and review that is highly advantageous over traditional models.

More specifically, for at least one embodiment pleasing shades of green are used to indicate low risk and insurance coverage, with pleasing shads of red being used to show gaps between assets and insurance as well as high risk. Indeed the use of pleasing shades that are not sharp or caustic in tone or intensity have been found to be more acceptable even when conveying negative information as they help indicate areas of concern but without an undertone of hostility. Of course it is understood and appreciated that “pleasing,” “sharp” and “caustic” are subjective terms and may vary from one Party to another, however, as used herein they are understood and appreciated to be terms as would be accepted by the average “Party” for their plain and ordinary meaning and relation to each other. For at least one other embodiment, the Party may optionally be given the opportunity to specify which particular colors he or she would like to assign for “good” and “bad” indicators. As such the transformation of data from the traditional numerical to the non-numerical graphical can be truly Party based.

To briefly summarize, provided is a system and method to determine without Third Party Subjectivity, and visually indicate with a Non-Numeric Graphic a Gap in insurance coverage for a Party. For at least one embodiment, this non-subjective determination is achieved by receiving from the Party, Party specific information including, name, age, address and annual income; presenting a set of Risk Evaluation questions to the Party and recording each risk evaluation answer as provided by the party; presenting a set of Risk Tolerance questions to the Party, each Risk Tolerance question providing a pre-defined set of answers, each answer corresponding to a pre-determined numeric value; recording each Risk Tolerance answer and tallying the assigned values of each answer, and based on the aggregate value rendering an initial non-numeric graphic conceptualizing the Party's indicated risk level; receiving from the Party an Insurance Inventory, including nature and an amount of coverage for each type of Insurance provided in the Insurance Inventory; receiving from the Party an Asset Inventory, including a nature and a value amount for each Asset provided in the Asset Inventory, the Asset Inventory further including a calculation of future income from the Party specific information of age and annual income; processing the Insurance Inventory and the Asset Inventory to determine an initial Gap value between total initial insurance value and total initial asset value, and based on the initial Gap valuation rendering at least one Non-Numeric Graphic conceptualizing the Party's Gap in insurance coverage; and permitting the Party to select one or more Solution options of different insurance types and amounts, and rendering at least one Non-Numeric Graphic conceptualizing the Party's Solution for insurance coverage for visual comparison with the Party's Gap in insurance coverage, the initial Gap and the Solution determined directly from information provided by the Party and without third-party subjectivity.

This summary may be more fully appreciated with respect to the following description and accompanying figures.

Turning now to the Figures, and more specifically to FIG. 1 there is shown a high level diagram of an embodiment of the Gap Determination and Solution System 100, hereinafter GDSS 100. As shown GDSS 100 is generally comprised of at least six modules, a party initializer module 102, a risk module 104, an asset inventory module 106, an insurance inventory module 108, a processing module 110 and a visualizer module 112. These modules are in communication with a database 114 for the storage and retrieval of information and may also be in direct communication with each other.

As illustrated, for at least one embodiment GDSS 100 is provided in the embodiment of a tablet style computing device 116. For yet another embodiment, GDSS 100 is provided as a desktop computer 118 or laptop, not shown.

For at least one embodiment, each module is implemented as a collection of independent electronic circuits packaged as a unit upon a printed circuit board or as a chip attached to a circuit board or other element of a computer so as to provide a basic function within a computer. In varying embodiments, one or more modules may also be implemented as software which adapts a computer to perform a specific task or basic function as part of a greater whole. Further still, in yet other embodiments one or more modules may be provided by a mix of both software and independent electronic circuits.

Each of these modules and their operations as part of the GDSS 100 will be discussed with respect to an exemplary walk through of at least one method as described below. However, a brief overview here is provided so as to frame the context of operation for GDSS 100.

The Party Initializer module 102 serves to collect from a Party specific information from the party. For at least one embodiment, this Party Specific Information includes name, age, address and annual income. This Party specific information is stored in the database 114 so as to be available for use with additional modules as well as a variety of other potential uses, such as but not limited to Party/Client database for future business use, comparison of various elements with other Party's to identify trends, etc . . .

The Risk module 104 serves to present the Party with a first set of questions to collect information regarding risk evaluation and a second set of questions regarding Risk tolerance. Each set of questions has a pre-determined set of optional answers with each answer correlating to a different point value.

The Asset Inventory module 106 serves to collect from the Party an inventory of the Party's assets, such as but not limited to bank account types and balances, investment account types and balances, personal property values, real estate value, and value of future income based on current age, current annual income and expected retirement age.

The Insurance Inventory module 108 serves to collect from the Party an inventory of the Party's insurance information regarding the nature and amount of coverage for each type of insurance presently held by, or for the interest of the Party. For example, in at least one embodiment, the insurance information collected regards one or more types of auto insurance, home insurance, life insurance, disability insurance, collectables insurance, specialty insurance, and umbrella insurance.

The Processing module 110 serves to permit comparative processing of the Insurance Inventory with the Asset Inventory to determine an initial Gap value between the Party's initial insurance value and initial asset value. The processing module 110 also serves to permit the Party to specify one or more Solution options for an additional type and amount of insurance and determine a Solution value for application to the determined Gap value. For at least one embodiment, the Solution options are selected from the group consisting of, auto liability insurance, home liability insurance; life insurance, and umbrella insurance.

The Visualizer module 112 serves to render non-numeric graphics conceptualizing the Party's Risk Tolerance, the Gap value between the party's initial insurance value and initial asset value, and the Solution for insurance coverage. Moreover, for at least one embodiment, the visualizer module 112 transforms the numeric data that has been collected and generated regarding the Party and his or her assets, their existing coverage, and risk tolerance into the Non-Numeric Graphics. Again, this is not to say that numbers and text may not be provide as well—but the essence of the Non-Numeric Graphics is that the Party can instinctively understand them without reliance upon a third party for explanation, as is often required with a numerical table or chart. Indeed it is to be understood and appreciated that the underlying numerical data that could be presented in a numerical chart or table is unchanged, but it's form as represented to the Party has.

A further appreciation for the advantageous nature off the Non-Numeric Graphics may be understood by considering how the world is understood by children. More specifically, even without the mastery of reading and writing, or perhaps even understanding numbers in terms of computation or even simple ordering, children can and do recognize one bar to be longer than another, one rectangle as larger than another, a whole circle as being more complete then a half circle, as well as equivalency, and that color often has meaning too—that green is often good while red is often bad. This understanding is not dependent upon the presence of numbers or words, and even if the number or words were present, for the child who can not yet read the text or numbers are merely superfluous as meaning can be directly understood from the Non-Numeric Graphics themselves.

The GDSS 100 system most certainly has the underlying numerical data that might otherwise be presented in a chart or table, but the method and form of presenting this data to the Party is significantly and advantageously different—the Non-Numeric Graphics are the centerpieces of the analysis and review. These Non-Numeric Graphics visually represent to the Party any determined Gaps in insurance selected from: auto liability, home owner liability, lifestyle of the Party, disability, and insured assets as determined by the processing module 110.

Moreover it is the interaction of these modules 102-112 collectively as the GDSS 100 which advantageously permit the Party to visually understand and perceive his or her current Asset to Insurance relationship, and any appreciable Gap there between. Further, although an Insurance Agent may work with the Party and the GDSS 100, third party subjectivity from the Insurance Agent is advantageously avoided—the Party can directly see how different Solutions alter his or her situation as each different Solution generates a new Non-Numeric Graphic for review and/or comparison, and thereby feel comfort that the determined Solution is much more a product of his or her desires and aspirations then is commonly felt or perceived in a more traditional insurance review and assessment setting.

With respect to FIG. 1, it is understood and appreciated that the basic elements of GDSS 100, e.g., the party initializer module 102, the risk module 104, the asset inventory module 106, the insurance inventory module 108, the processing module 110, the visualizer module 112, and the database 114 are in one embodiment located within a single device, such as for example a computer having at least one processor. In at least one alternative embodiment, these elements may be distributed over a plurality of interconnected devices. Further, although each of these elements has been shown conceptually as a single element, it is understood and appreciated that in varying embodiments each element may be further subdivided and/or integrated within one or more elements.

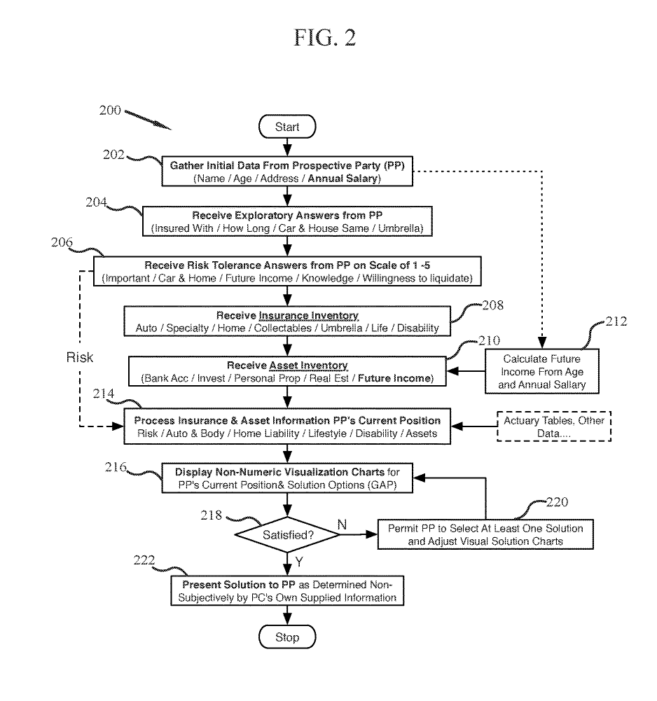

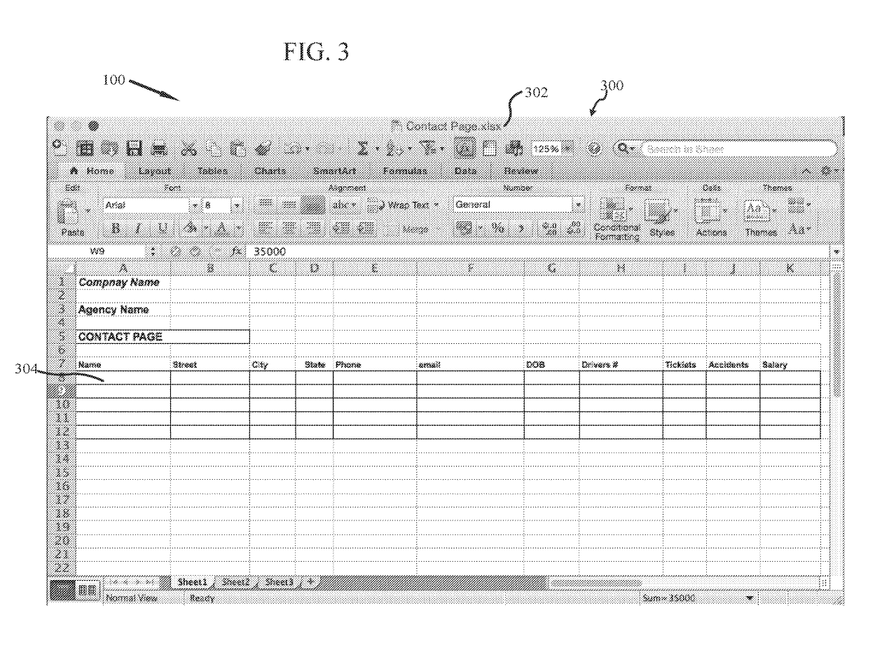

Having described the general embodiment for GDSS 100 as shown with respect to FIG. 1, other embodiments relating to the use of GDSS 100 and the method of implementing GDSS 100 will now be discussed with respect to FIGS. 2-21 in connection with FIG. 1. Moreover, FIG. 2 provides a high level flow diagram with FIGS. 3-21 providing conceptual screen shot illustrations for at least one method of implementing of determining a Gap between Insurance and Assets without third party subjectivity. It will be appreciated that the described method need not be performed in the order in which it is herein described, but that this description is merely exemplary of one method of determining a Gap between Insurance and Assets without third party subjectivity.

In general, method 200 commences with the gathering of initial data from a prospective client/Party, block 202. FIG. 3 presents a conceptualized application window 300 for an embodiment of GDSS 100, and more specifically a screen shot for a Client Contact Page 302, clearly showing spaces for a Party data input. For the present example, the application window 300 is shown as spreadsheet application, such as for Microsoft Excel®, however it should be understood and appreciated that the GDSS 100 application may be provided as a customized application or web browser application without departing from the scope of the present invention. Indeed, GDSS 100 may be provided as a web based, or cloud based application which may be directly accessed by a customer/Party for his or her own use.

Moreover, it should be understood and appreciated that varying embodiments of GDSS 100 are applicable to Parties as persons—individuals or families, where names and addresses are those of the Party and spouse or domestic partner, address is the primary physical address and annual income is annual salary. This is the exemplary setting as illustrated in FIG. 3, however it is understood and appreciated that other embodiments of GDSS 100 are applicable for a Party as an Entity, such as business, corporation or company, age being the years in existence.

Returning to the present example as shown in FIG. 3, the Client Contact Page 302 provides various data entry cells 304, so as to assist and identify the types of Party information being collected—name, street, city, state, phone, email, DOB, Drivers #, Tickets, Accident and Salary being exemplary labels for the present example.

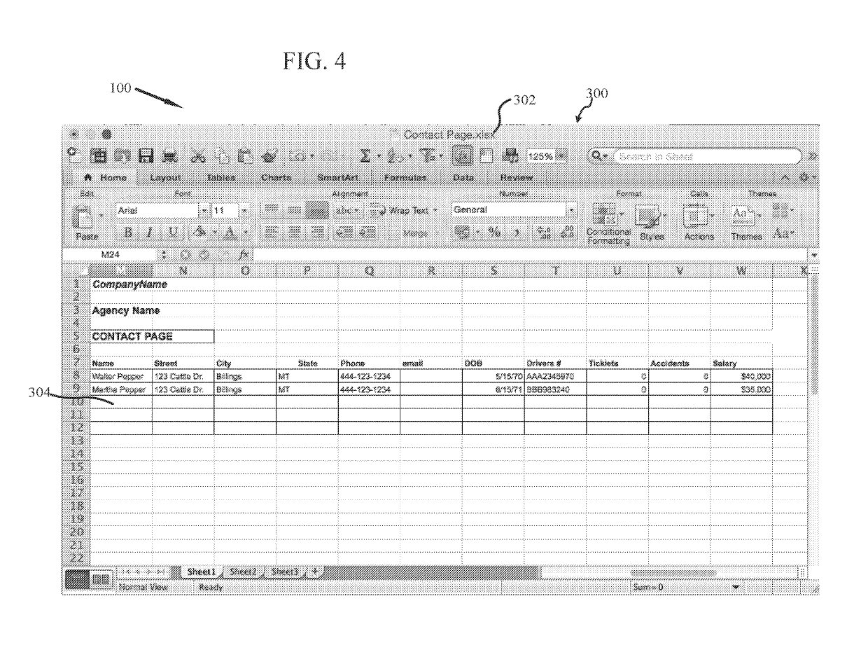

Continuing with the present example, FIG. 4 shows the Client Contact Page 302 of the application window 300 substantially completed with sufficient information to advance the review process. For the present example, the Party is understood and appreciated to be the husband and wife, Walter Pepper and Martha Pepper, as they are utilizing GDSS 100 to review their Insurance and Assets to determine any Gap there between. Moreover the term Party collectively refers to these two individuals in the continuation of this present example This Party data is captured by the database 114 (see FIG. 1) element of GDSS 100 and as such may be recalled, processed or otherwise used and acted upon as desired for operation of GDSS 100 and method 200.

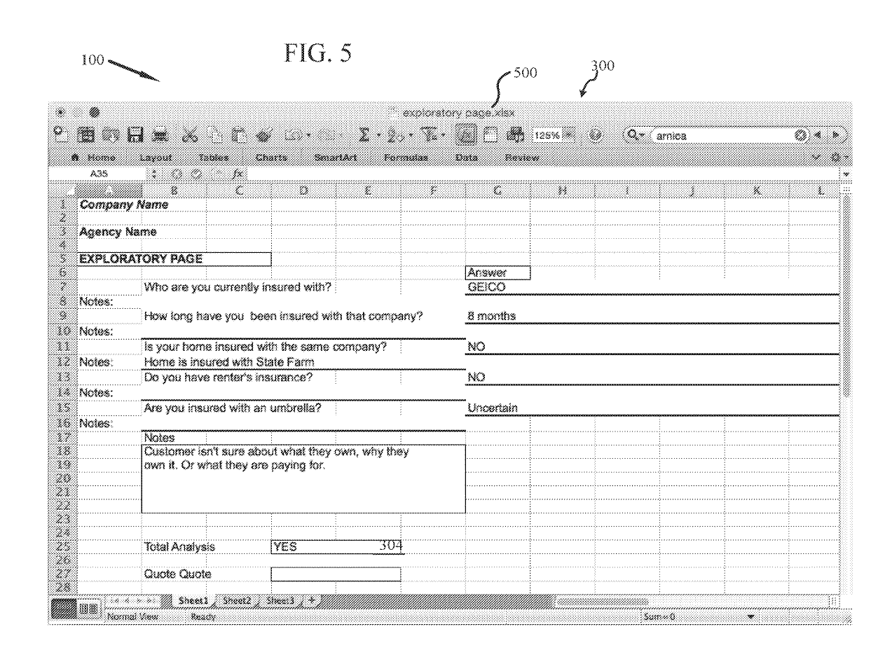

From the Client Contact Page 302, method 200 continues to an Exploratory Page 500 as shown in FIG. 5, so as to receive exploratory answers from the party, block 204. This page is primarily for the gathering of background information generally regarding the Party's present insurance state—do they presently have insurance, who are they presently insured with. Simple and direct, these questions help set the stage with the Party in understanding that the review and assessment is about them, as well as capturing data that may be of future assistance in working with the Party.

The answers provided by the Party with respect to the Exploratory Page 500 may trigger an exit from a continuation of method 200. If the Party is a first timer with respect to any insurance then what assets they have are clearly uninsured and no further processing is required to understand that the Party has no coverage and all is at risk.

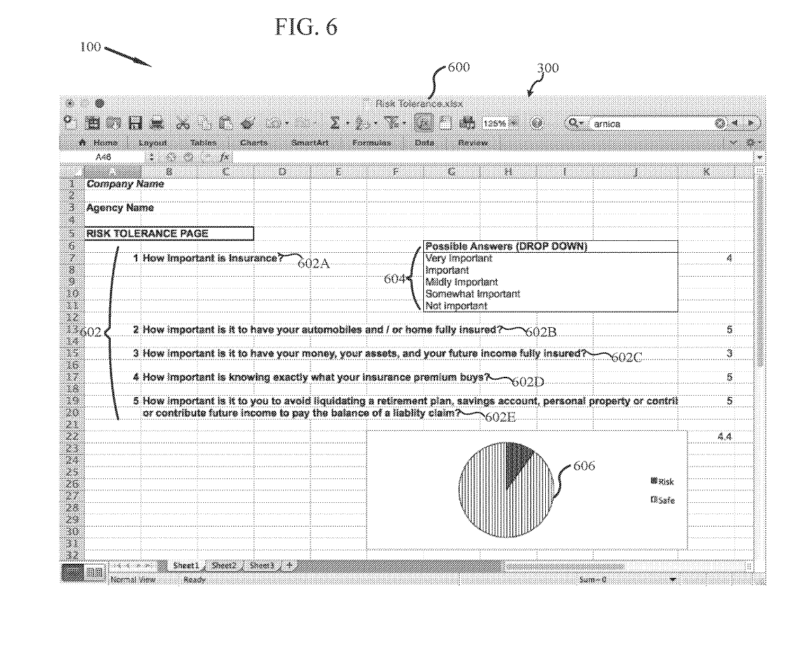

As shown in FIG. 2, method 200 then advances to receiving risk tolerance answers from the Party, block 206. Moreover, FIG. 6 illustrates the Risk Tolerance Page 600. In contrast to the Exploratory Page 500 which presents open ended questions, the Risk Tolerance Page 600 is specifically focused on establishing a simple and direct assessment of the Party's Risk Tolerance through the use of questions 602 having a pre-determined set of answers 604. Through the course of experimentation and review it has been determined that a simple set of perhaps five (5) direct questions 602A-602E are sufficient to establish the party's risk tolerance.

For at least one exemplary embodiment as shown these questions are:
1—How Important Is Insurance?
2—How important is it to you to have your automobiles and/or home fully insured?
3—How important is it to have your money, your assets, and your future income fully insured?
4—How important is knowing exactly what your insurance premium buys?
5—How important is it to you to avoid liquidating a retirement plan, savings account, personal property or contributing future income to pay the balance of a liability claim?

For each of the five questions 602A-602E the Party is presented with a drop down selection of answers 604, and each answer has a predefined point value—Very Important (5 points), Important (4 points), Mildly Important (3 points), Somewhat Important (2 points), Not Important (1 point).

In direct response to the selection of each answer 604, GDSS 100 renders a Non-Numeric Graphic for Risk Tolerance 606. Through the use of color and/or shading, the Party is thereby provided with a simple and intuitive representation of their Risk Tolerance. Further, if the party desires, he or she can re-evaluate and change one or more of the selected answers. Moreover, Risk Tolerance is an issue many people have not truly considered. As GDSS 100 permits with the application window 300, a Party can quickly gain insight in to their Risk Tolerance and potentially gain an understanding that they are more or less risk tolerant than they would have otherwise expected.

As noted above, GDSS 100 advantageously identifies any Gap between a Party's Assets and Insurance, and again, this determined numeric value of the Gap is transformed to be presented to the Party in one or more Non-Numeric Graphics. To facilitate this, an Insurance Inventory and an Asset Inventory for the party are obtained. Moreover, method 200 advances to receiving an insurance inventory, block 208.

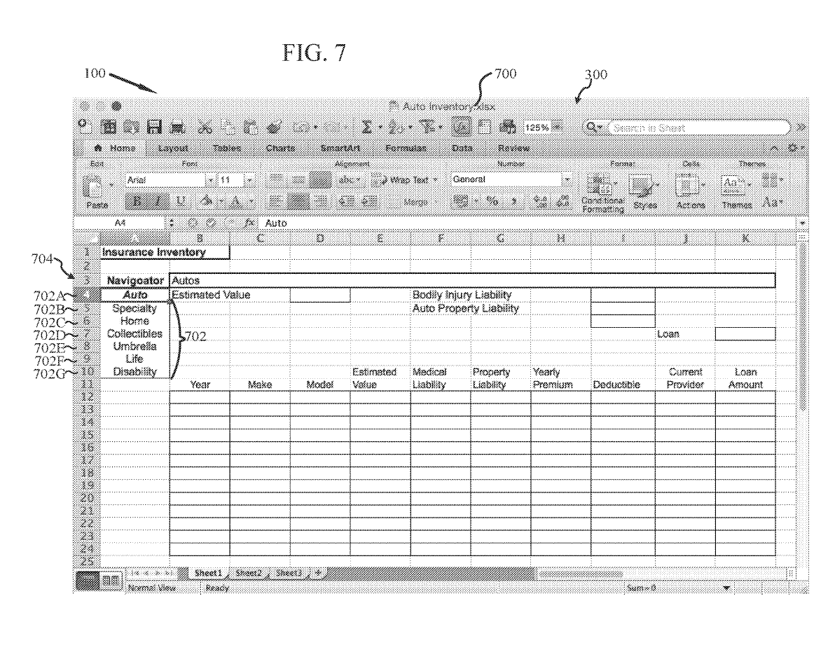

In FIG. 7, the application window 300 now presents the Insurance Inventory page 700 as a template for the gathering of Insurance information. Moreover, a plurality of different types of insurance 702 have been pre-specified, such as Auto 702A, Specialty 702B, Home 702C, Collectibles 702D, Umbrella 702E, Life 702F and Disability 702G. These types of insurance 702 are present for selection under the Navigator 704 as they may be relevant for a Party.

Of course the order in which these types of insurance have been presented is by way of example only, not limitation. Indeed the labels as applied may change as may be preferred in varying embodiments as well. It is understood and appreciated that not every Party will have the same types of insurance, and indeed GDSS 100 is structured and arranged to accommodate this.

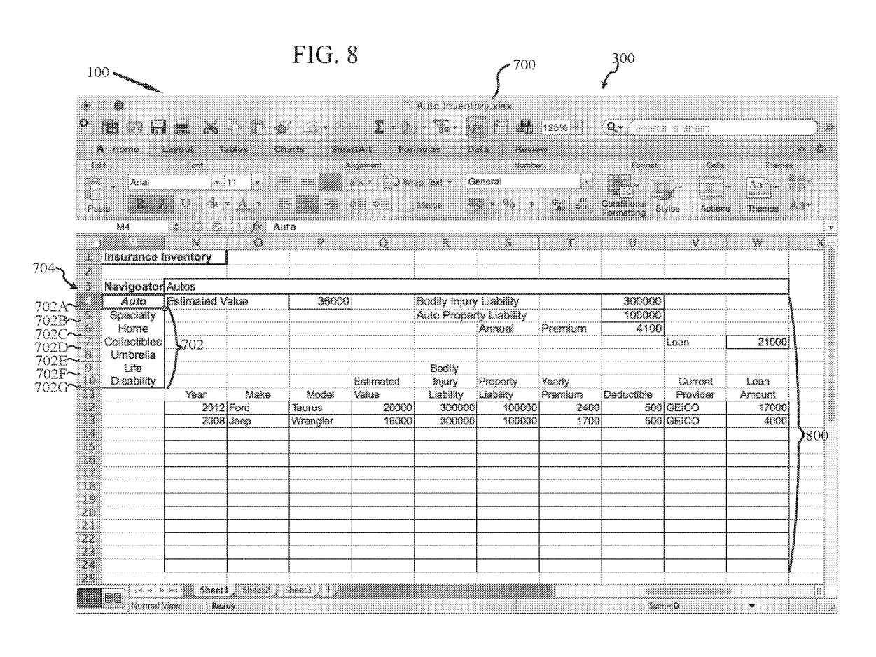

In FIG. 8, Auto 702A has been selected under the navigator 704 such that the application window 300 now presents Autos as a subsection 800 of the Insurance Inventory Page 700. As shown, the Autos subsection 800 is an exemplary template for gathering insurance data regarding the automobiles of the Party shown in FIG. 4—two vehicles, a Ford Taurus and a Jeep Wrangler. This page has been pre-defined so as to provide specific areas for specifying the nature of the vehicles, their estimated values, coverage amounts, deductibles and loan. Moreover, as FIG. 8 illustrates, GDSS 100 is collecting specific data directly from the Party in a direct and non-subjective manner.

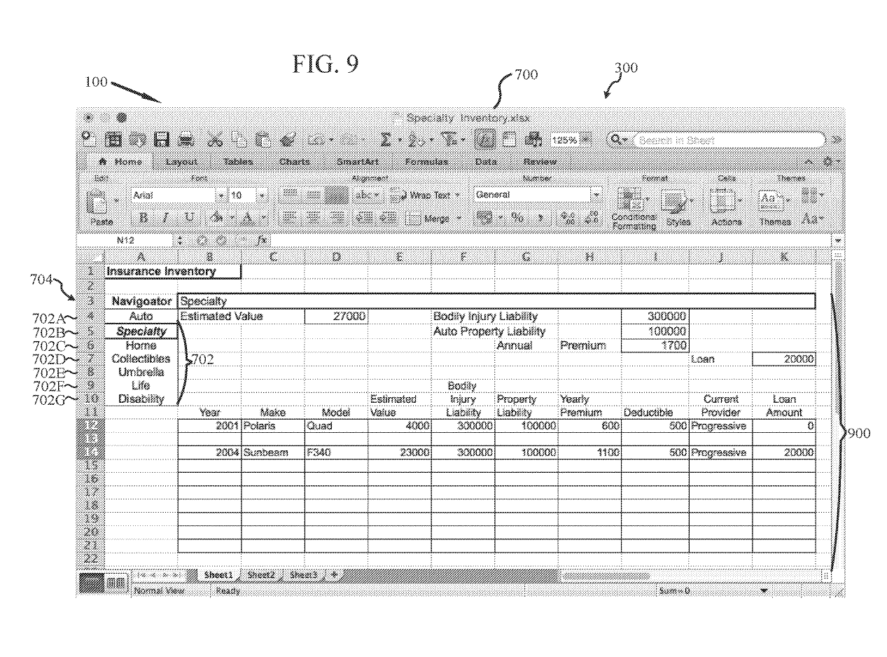

Following the collection of any auto related insurance, In FIG. 9, the navigator 704 is used to select Specialty 702B such that the application window 300 now presents Specialty as a subsection 900 of the Insurance Inventory Page 700. As shown, the Specialty subsection 900 is an exemplary template for gathering insurance data regarding the insured specialty items of the Party shown in FIG. 4. As shown, the Party has a Polaris Quad recreational vehicle and a Sumbeam F340, the details of the respective insurance clearly noted.

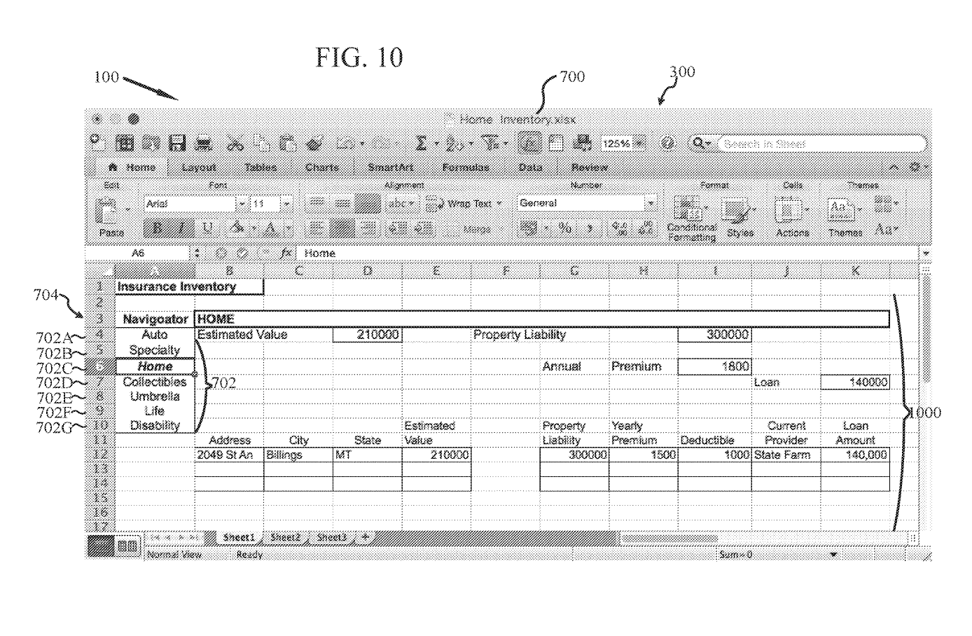

Continuing, in FIG. 10 Home 702C has been selected under the navigator 704 such that the application window 300 now presents Home as a subsection 1000 of the Insurance inventory Page 700. As shown, the Home subsection 1000 is an exemplary template for gathering insurance data regarding the home(s) of the Party shown in FIG. 4. For the present example the Party has listed one home and the details of the home and the current insurance are noted in a simple and direct fashion—they have one home with an address in Montana, Property liability in the amount of $300,000.00, a yearly premium of $1,800, a deductible of $1,000, the policy is with State Farm and the current loan amount is $140,000.00

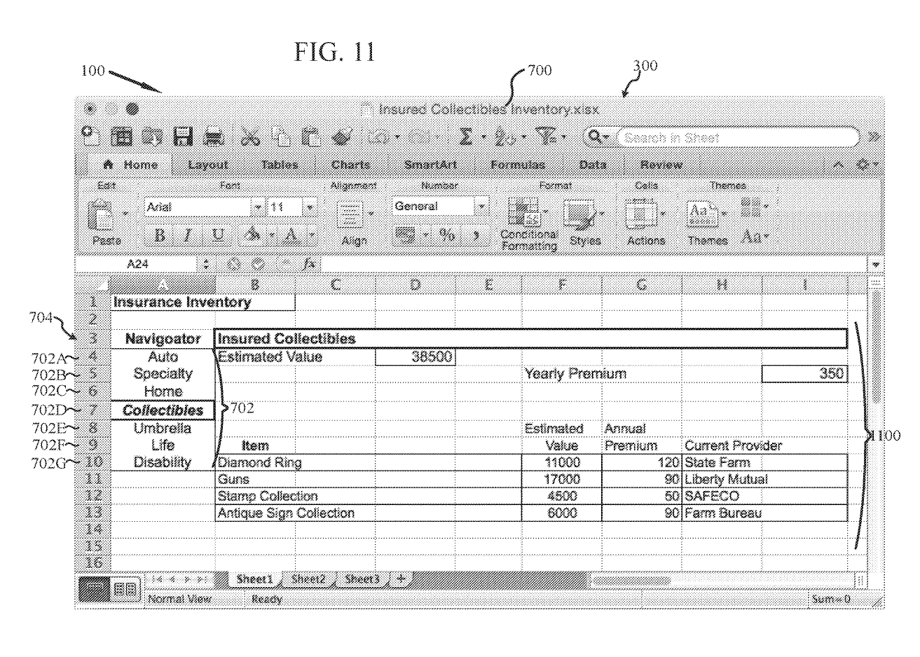

Moving on, in FIG. 11 Collectibles 702D has been selected under the navigator 804 such that the application window 300 now presents Collectibles as a subsection 1100 of the Insurance inventory Page 700. As shown, the Collectibles subsection 1100 is an exemplary template for gathering insurance data regarding the collectibles(s) of the Party shown in FIG. 4. For the present example, the Party has specified a Diamond Ring, Guns, a Stamp Collection, and an Antique Sign Collection as being specialty items covered by specific insurance as noted. As a component of the Insurance Inventory, the assessed asset value determined for the Collectables 702D is automatically included as a component of total asset value for the Party.

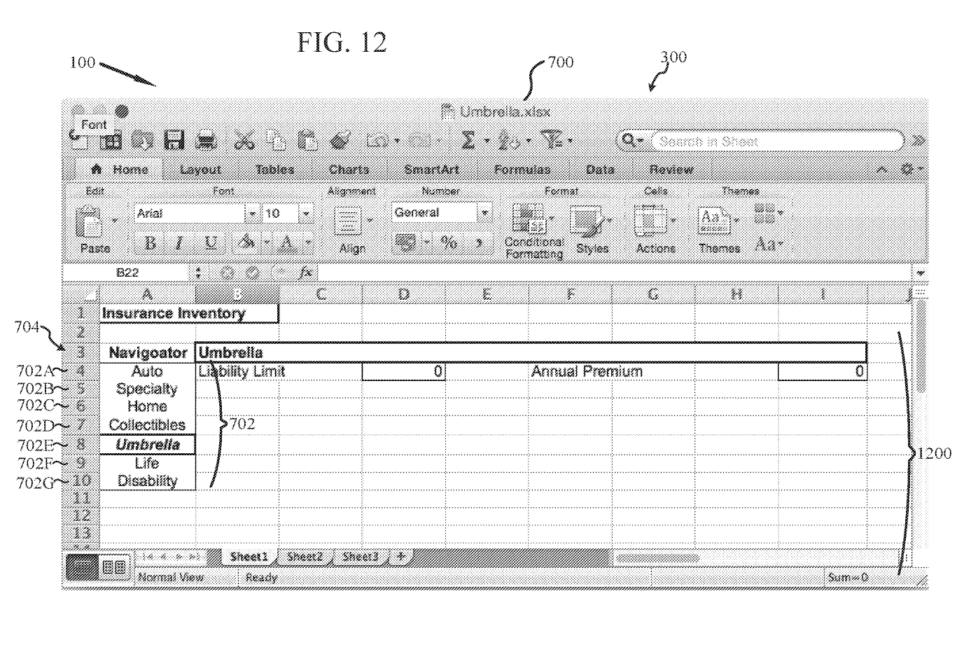

Continuing, in FIG. 12 Umbrella 702E has been selected under the navigator 704 such that the application window 300 now presents Umbrella as a subsection 1200 of the Insurance inventory Page 700. As shown, the Umbrella subsection 1200 is an exemplary template for gathering insurance data regarding any Umbrella insurance policies of the Party shown in FIG. 4. As shown, the Umbrella page is an exemplary template for gathering insurance data regarding the any umbrella insurance policies of the Party shown in FIG. 4. For the present example the Party has no umbrella policies.

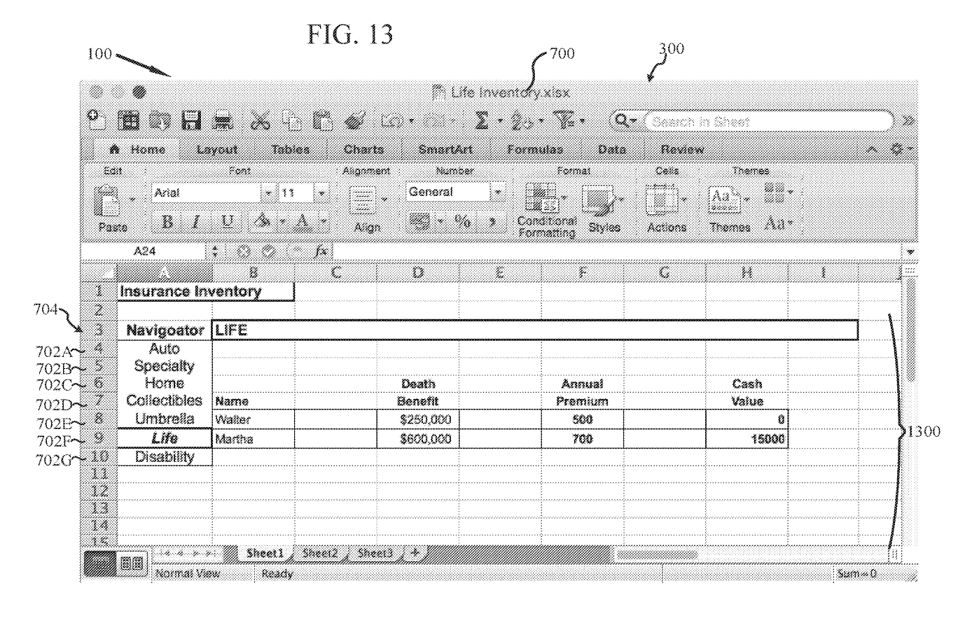

Moving on, in FIG. 13 Life 702F has been selected under the navigator 704 such that the application window 300 now presents Life as a subsection 1300 of the Insurance inventory page 700. As shown, the Life subsection 1300 is an exemplary template for gathering insurance data regarding any Life insurance for the Party shown in FIG. 4. Moreover, as shown Martha has life insurance providing a death benefit of $600,000 with an annual premium of $700 and a cash value of $15,000. Walter has life insurance providing a death benefit of $250,000 with an annual premium of $500 and no cash value.

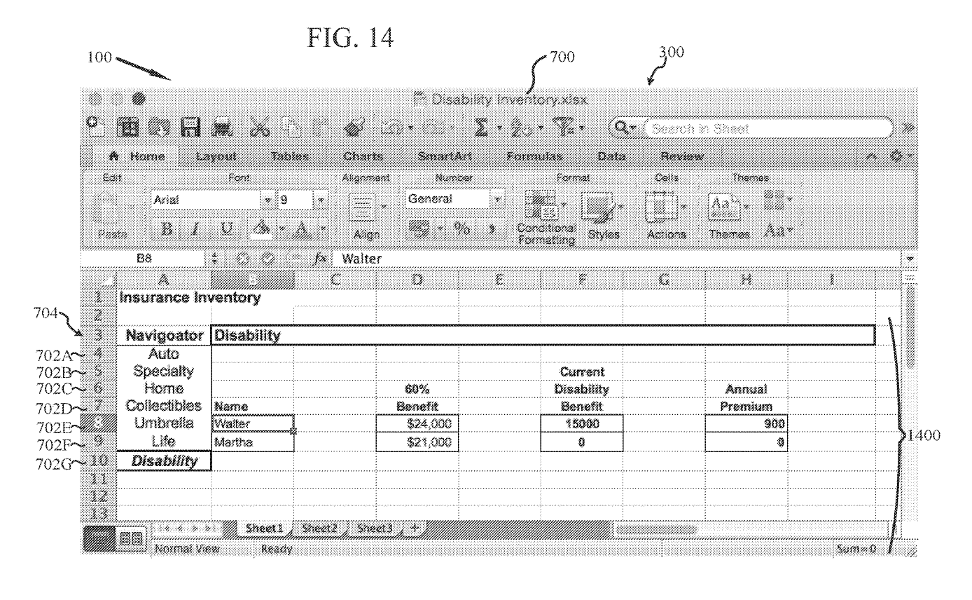

Lastly for the present example, in FIG. 14 Disability 702G has been selected under the navigator 704 such that the application window 300 now presents Disability as a subsection 1400 of the Insurance inventory page 700. As shown the Disability subsection 1400 is an exemplary template for gathering insurance data regarding any Disability insurance for the Party shown in FIG. 4. As shown, for the present example Walter has specified disability insurance providing a $15,000 annual benefit, which is 63% of the total disability possible of $24,000. Walter has a disability GAP of 37%. Martha has $0 current disability benefit of a possible 60% disability value of $21,000. Martha has a disability gap of 100% or $21,000.

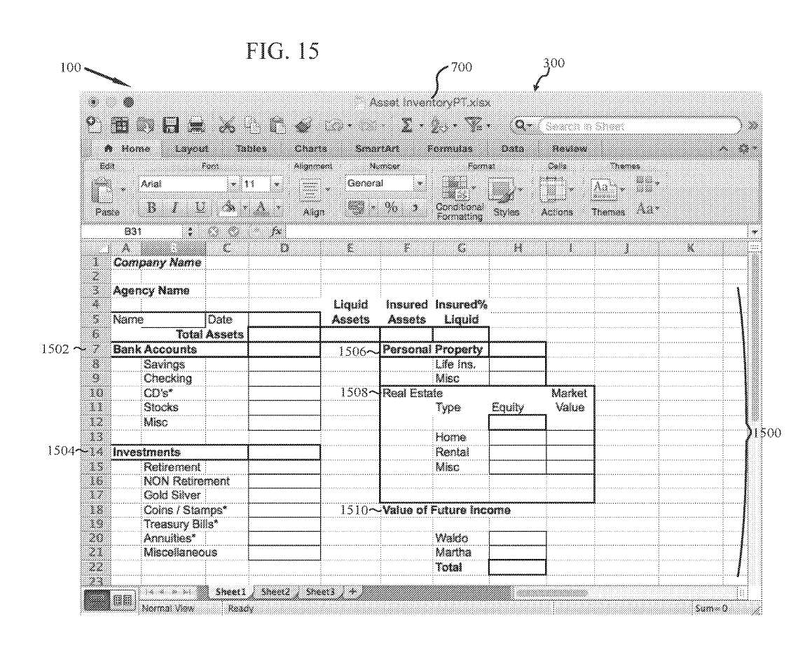

Method 200 now continues by advancing to receive an Asset Inventory from the Party, block 210. The application window 300 now presents the Asset Inventory page 1500 as shown in FIG. 15. As shown, the Asset Inventory subsection 1500 is an exemplary template for gathering Asset data regarding any assets of the Party shown in FIG. 4. For the present example as prepared for a Party being a married couple, the Asset Inventory page 1500 is shown to present collection cells for Bank Account 1502, Investments 1504, Personal Property 1506, Real Estate 1508 and the Value of Future Income 1510.

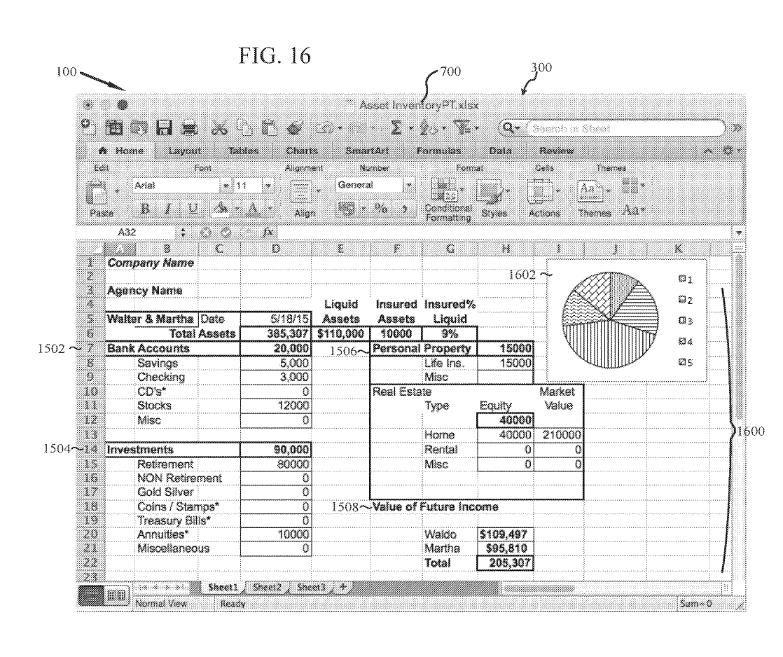

FIG. 16 illustrates the Asset Inventory page now completed 1600. For at least one embodiment elements from the Insurance Inventory, such as the Home Market Value may be retrieved from the database 114 to automatically populate fields such as Home Value and the individual or combined value of the Specialty and Collectable items. For the present example, the Party has specified several different bank accounts, investments, personal property, and home. In addition to these provided fields, GDSS 100 retrieves from the database 114 information regarding the Party's current income, age and expected retirement age so as to determine the Party's predicted Future Income, block 212 in FIG. 2.

Attention is also directed to the Non-Numeric Graphic 1602 which visually depicts to the Party how the specified Assets relate to one another in the makeup of the Asset inventory. In sharp contrast to the traditional system and methods which present asset values and insurance coverage and potential gaps there between in numerical charts and tables, which by their very nature may be abstract to the layperson Party, the transformation of this underlying data into Non-Numeric Graphic 1602 is highly advantageous. Moreover, GDSS 100 is not merely collecting, processing and presenting data in a typical and traditionally expected format—GDSS 100 is transformative. The Party is principally responsible for providing the data to GDSS 100 and therefore the Party is vested with control of the process and the specter of third party subjectivity is thereby reduced. Additionally, the Non-Numeric Graphics are intuitively understood. Presented as a pie chart in the exemplary case of Non-Numeric Graphic 1602, this information is easy to understand by the Party. Although shown in the present example with hatching, color may be implanted in varying embodiments that are not restricted to black and white.

Of course numerical tables may be easily and quickly understood by some, but the essence of GDSS 100 is that the numerical data is transformed for presentation to the Party in a form that is not expressly dependent upon the Party interpreting numbers. Even without a masterly of written language or numerical computation, children can and do recognize one bars that are longer then other bars, whole discs to be different from half discs, and that some colors imply good while others imply bad. It is the ability to transform numerical data and render these Non-Numeric Graphics that make embodiments of GDSS 100 transformative in the present field.

With the Asset Inventory and Insurance Inventory now complete, method 200 continues by processing the insurance and asset information to determine the Party's current position and any general or specific Gap as between insurance and assets, block 214. In processing this information, in optional embodiments, GDSS 100 may optionally employ actuarial tables or other information regarding aspects of the data provided by the Party, such as their age, address, or other factors so as to prepare an unbiased report based on the Party provided data.

As a component of this processing, the Party's Risk Tolerance as determined earlier in method 200 is retrieved and incorporated. More specifically, GDSS 100 advantageously permits a Party to intuitively understand the relationship between Assets and Insurance. GDSS 100 advantageously this by generating and presenting Non-Numeric Graphics to the Party which visually illustrate the Party's Asset and Insurance information as provided by the Party without third party subjectivity and any Gap there between, both generally overall as well as for specific types of assets and insurance, i.e., home and auto.

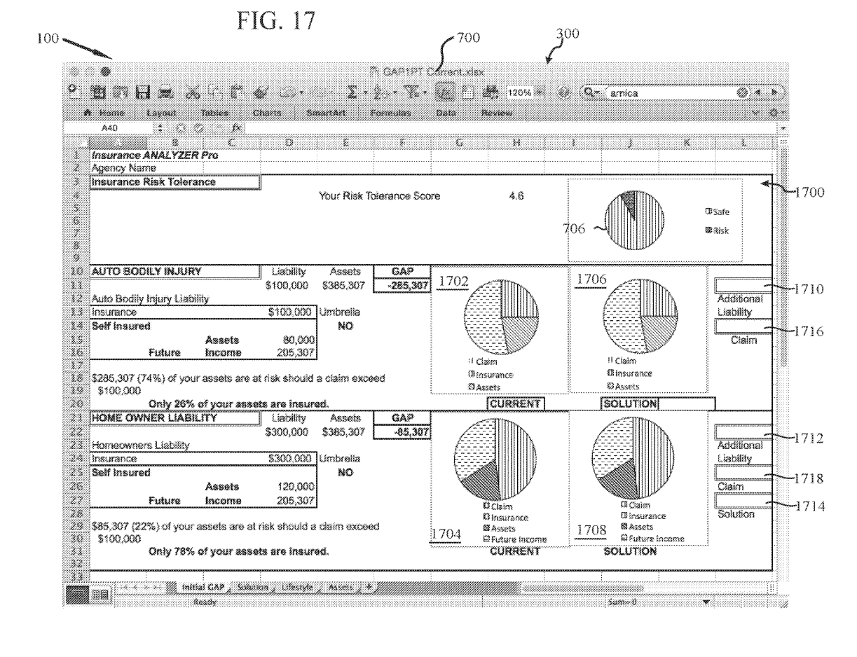

Moreover, method 200 prepared and displays Non-Numeric Graphics regarding the parties current position and possible Solutions, block 216. Further, method 200 permits the Party to review the Gap information and revise at least one Solution option, decision 218 and block 220. This advantageous review and revision process may be more fully appreciated with respect to FIGS. 17-19.

FIG. 17-19 illustrate the application window 300 now presenting the results of the Gaps as between Assets and Insurance as determined by GDSS 100 applying method 200. For an active embodiment provided on a computer system, it is intended that the party may scroll the report. For ease of illustration and description, the results page has been broken into different sections, which are understood to appear collectively as a complete and scrollable page in at least one embodiment.

Moreover, FIG. 17 presents the top portion of the Gap Results 1700—and at the outset re-presents the Party's determined Risk Tolerance Non-Numeric Graphic 706 as previously determined above. The arrangement of the rest of the results report may be modified as desired for different embodiments, such as for example to show a progression of least Gap to greatest Gap with respect to different issue.

For example, as shown in FIG. 17, presented below the initial Risk Tolerance Non-Numeric Graphic 706 is a report of the Gap in Auto Body Injury 1702 and Home Owner Liability 1704. For at least one embodiment, these Non-Numeric Graphics are represented as pie charts. Directly to the right of each is a Solution based Non-Numeric Graphic, i.e. Auto Body Injury Solution Graphic 1706 and Home Owner Liability Graphic 1708.

As no Solution has yet been selected or amount provided, initially the Solution Graphics 1706 and 1708 are identical to the Gap Graphics 1702 and 1704. As GDSS 100 is an interactive system and method, it is further appreciated that the results page provides input areas to receive various Solution options, i.e., additional Auto Liability insurance 1710 and Home Owner Insurance 1712 as well as an Umbrella Insurance Solution 1714 option. In addition, options to explore potential claims may also be provided, i.e., the option for an Auto claim 1716 or a Home Owners claims 1718.

More specifically, when and as the Party specifies different types of Solution options and amounts, the Results page 1700 automatically updates the Auto Body Injury Solution Graphic 1706 and Home Owner Liability Graphic 1708 so as to provide the Party with an intuitive, non-numeric visual representation of how each specified Solution affects their position.

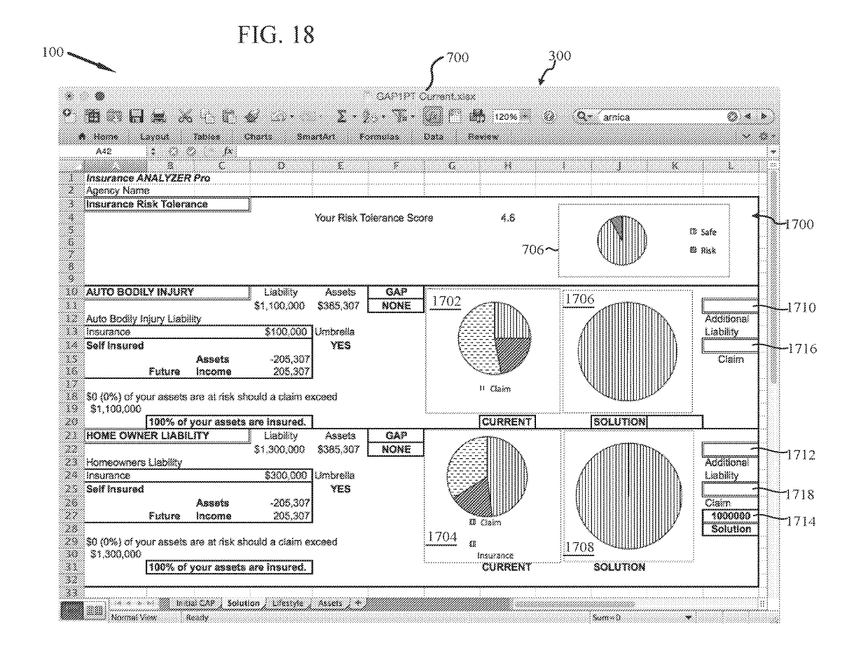

This update is shown in FIG. 18, as a Solution of an additional $1,000,000.00 in Umbrella Insurance has been specified in entry box 1714.

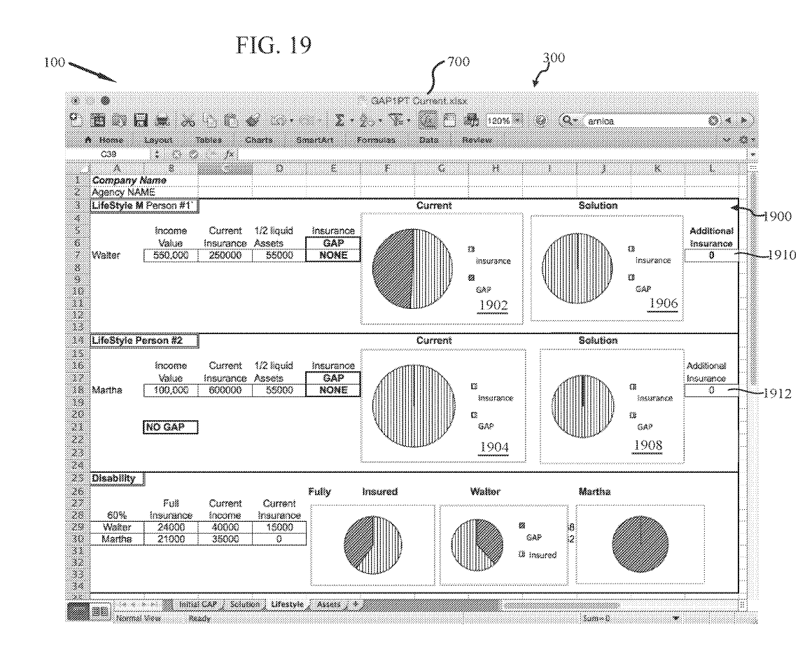

FIG. 19 illustrates the application window 300 for Results for review of the Lifestyle Gap for the Parties 1900, Walter and Martha Pepper as specified in the Contact Page of FIG. 4. Here again for each of them a Non-Numeric Graphic 1902, 1904 is shown depicting their respective current positions and the Gap in coverage as determined by the Party provided information. Directly to the right of each is a Solution based Non-Numeric Graphic, i.e. Solution Graph 1906 corresponding to Non-Numeric Graphic 1902 and Solution Graph 1908 corresponding to Non-Numeric Graphic 1904. And as above, the Party is permitted the opportunity to experiment with at least one Solution option and see very quickly how additional amounts of insurance will affect the determined Gap regarding Lifestyle matters.

Moreover, as the Umbrella Solution is applicable only to Home and Auto, but GDSS 100 has operated to determine all areas of Gaps in insurance, two Solution options are shown—additional traditional insurance 1910 for the first person (Walter), additional traditional insurance 1912 for the second person (Martha).

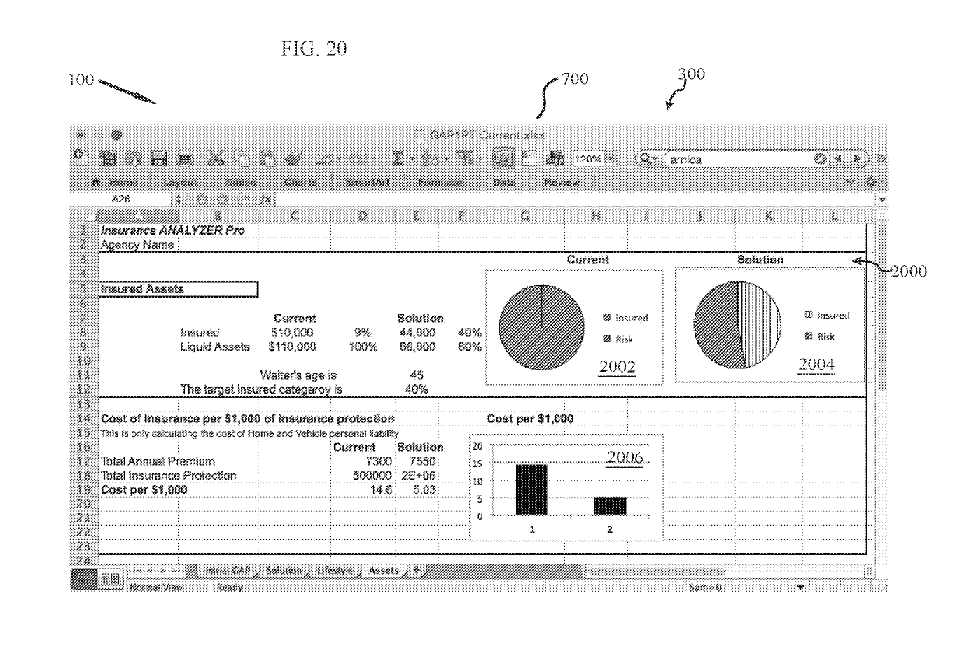

FIG. 20 illustrates the application window 300 for Results for review of the Insured Assets 2000. As with the above Results for Auto, Home, and Life, this Results for Insured Assets 2000 page provides a Non-Numeric Graphic 2002 showing the current Gaps as well as a Solution Graph 2004. As with the above results, the Solution Graph 2004 is drive by the provided Solution, which in the present example is the Umbrella Solution of an additional $100,000.00. In addition, FIG. 20 provides a simple bar chart 2006 visually depicting the relative costs for eliminating the Gaps identified above through increases in the current specific types of insurance vs. the cost of a Solution provided by umbrella insurance.

When the Party is satisfied with a Solution, that selected Solution is presented to the Party and/or an agent who will assist the Party with the actual process of engaging the Solution. Again, as GDSS 100 and method 200 have involved the Party directly and present results directly in near real time with Non-Numeric Graphics to intuitively convey an understanding of where the Party is currently at with respect to Insurance and Assets and permitted the Party to explore at least one Solution to resolve one or more apparent Gaps, the system and method are highly advantageous as they avoid third party subjectivity and feelings of reluctance and uncertainty that may exist on the part of the Party.

To summarize, for at least one embodiment, provided is a method 200 to determine without third-Party subjectivity, and visually indicate with a non-numeric graphic a gap in insurance coverage for a Party, including: receiving from a Party a plurality of information items including, Party specific information, an indication of Risk Tolerance, an Insurance Inventory and an Asset Inventory; processing the received information items to determine Future Income for the Party and an initial gap value between total initial insurance value and total initial asset value, develop a non-numeric graphic representing Risk Tolerance; developing non-numeric graphics conceptualizing the Party's Risk Tolerance and gap in insurance coverage; permitting the Party to select one or more solution options of different insurance types and amounts, and rendering at least one non-numeric graphic conceptualizing the Party's solution for insurance coverage for visual comparison with the Party's gap in insurance coverage, the initial gap and the solution determined directly from information provided by the user and without third-Party subjectivity.

As noted above, the advantageous nature of GDSS 100 and/or method 200 are not strictly limited to individuals as Parties. Indeed one or more embodiments may be structured and arranged to permit a choice of Party types from within GDSS 100 and method 200, or various different embodiments may be established for a variety of different Party types.

Moreover, at least one embodiment of GDSS 100 and/or method 200 are as presented in the above example—applicable for personal lines of insurance. This embodiment may be used directly by the Party or with the assistance of an Agent to capture the current plan of insurance and provide Solutions through the use of the process evaluation and customer information. Yet another embodiment of GDSS 100 and/or method 200 is provided for a commercial agent who will use the system and/or method to capture the current plan of commercial insurance and provide Solutions through the Analyzer in much the same way as with a normal person. Again the commercial Party is advantageously permitted to participate and observe how the Solutions are realized without third party subjectivity.

In yet another embodiment, the GDSS 100 and/or method 200 is employed by an advisor who will use the system and method for the review of client accounts for planning purposes, and upon the identification of a Gap, to prepare a report so as to invite the Party to participate with the GDSS 100 and/or method 200 so as to discover first hand how one or more Solutions might be of benefit.

And yet for another embedment, the GDSS 100 and/or method 200 are implemented in an Agency setting. In such a setting the user of the database 114 provides further advantages for as all Agents will have an embodiment of the GDSS 100 and/or method 200 for use with potential clients, i.e., a Party, all information is captured and available for review by the agency owner. The information from the Exploratory Page shown in FIG. 5 can be reviewed as well as the Solutions and provided quotes for any selected Solutions. Moreover, the agency owner can maintain oversight to ensure that issues of third party subjectivity on behalf of agents do not become an issue, and Parties may rest assured that through the GDSS 100 and/or method 200 the review of their current situations, determination of any Gap(s) and possible Solution options are handled in an open, Party driven manner.

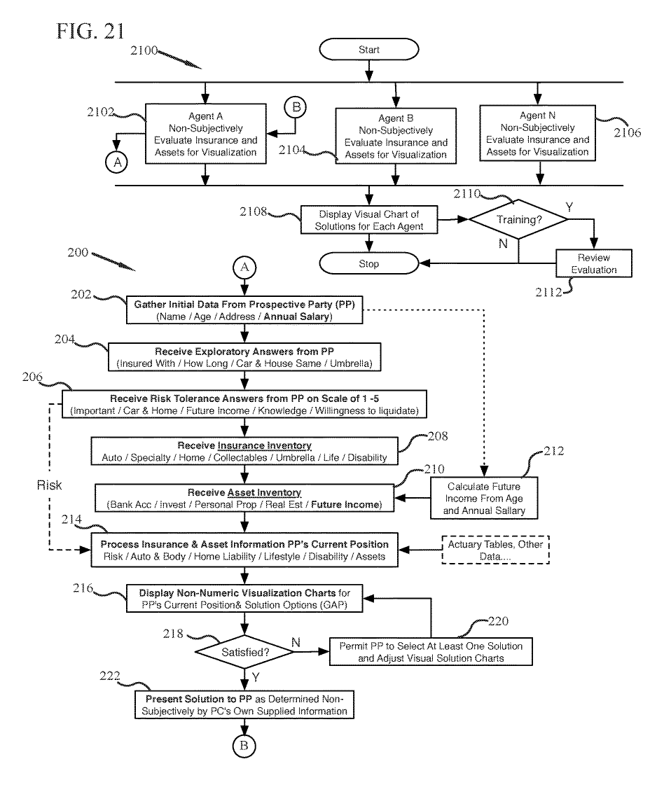

An embodiment for such an agency setting is shown in FIG. 21, presenting a flow diagram teaching method 2100 for a plurality of agents implementing the GDSS 100 and/or method 200 in separate sessions, blocks 2102, 2104 and 2106. Their progress and performance is provided for review, block 2108 so as to identify opportunities for additional training and performance evaluation, decision 2110 and block 2112.

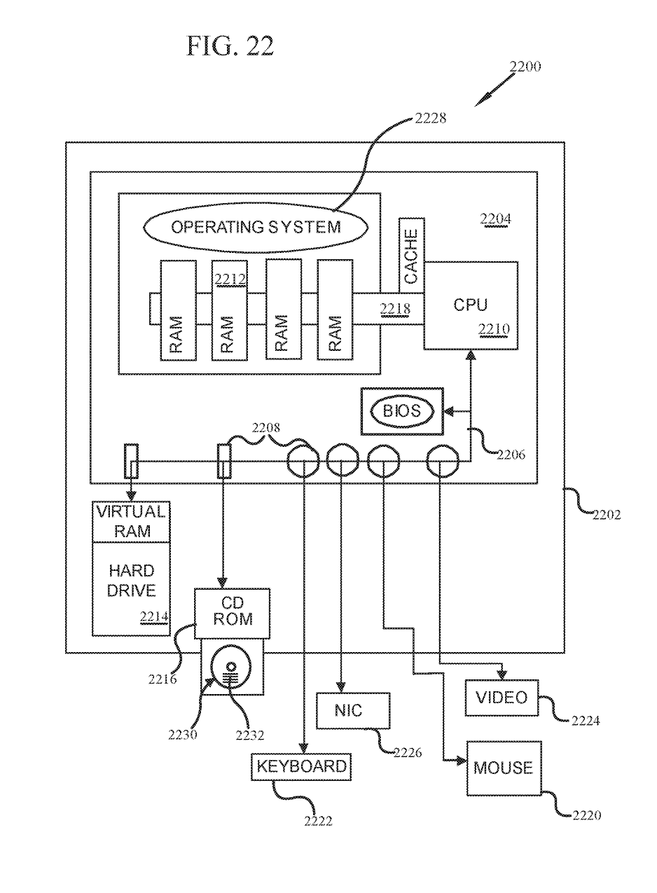

With respect to the above description of the GDSS 100 and method 200, & 2100, it is understood and appreciated that the method may be rendered in a variety of different forms of code and instruction as may be used for different computer systems and environments. To expand upon the initial suggestion of the modules as shown and described with respect to FIG. 1 and GDSS 100 as a whole or the modules themselves being computer system(s) adapted to their specific roles, FIG. 22 is a high level block diagram of an exemplary computer system 2200 such as may be provided for one or more of the elements comprising the GDSS 100 as a whole or the modules noted above.

Computer system 2200 has a case 2202, enclosing a main board 2204. The main board 2204 has a system bus 2206, connection ports 2208, a processing unit, such as Central Processing Unit (CPU) 2210 with at least one microprocessor (not shown) and a memory storage device, such as main memory 2212, hard drive 2214 and CD/DVD ROM drive 2216.

Memory bus 2218 couples main memory 2212 to the CPU 2210. A system bus 2206 couples the hard disc drive 2214, CD/DVD ROM drive 2216 and connection ports 2208 to the CPU 2210. Multiple input devices may be provided, such as, for example, a mouse 2220 and keyboard 2222. Multiple output devices may also be provided, such as, for example, a video monitor 2224 and a printer (not shown). As computer system 2200 is intended to be interconnected with other computer systems in a network a combined input/output device such as at least one network interface card, or NIC 2226 is also provided.

Computer system 2200 may be a commercially available system, such as a desktop workstation unit provided by IBM, Dell Computers, Gateway, Apple, or other computer system provider. Computer system 2200 may also be a networked computer system, wherein memory storage components such as hard drive 2214, additional CPUs 2210 and output devices such as printers are provided by physically separate computer systems commonly connected together in the network. Those skilled in the art will understand and appreciate that the physical composition of components and component interconnections are comprised by the computer system 2200, and select a computer system 2200 suitable for one or more of the computer systems incorporated in the formation and operation of GDSS 100.

When computer system 2200 is activated, preferably an operating system 2226 will load into main memory 2212 as part of the boot strap startup sequence and ready the computer system 2200 for operation. At the simplest level, and in the most general sense, the tasks of an operating system fall into specific categories, such as, process management, device management (including application and user interface management) and memory management, for example. The form of the computer-readable medium 2228 and language of the program 2230 are understood to be appropriate for and functionally cooperate with the computer system 2200.

Moreover, variations of computer system 2200 may be adapted to provide the physical elements of one or more components comprising each system, the switches, routers and such other components as may be desired and appropriate for the methods and systems of GDSS 100 and/or method 200.

Changes may be made in the above methods, systems and structures without departing from the scope hereof. It should thus be noted that the matter contained in the above description and/or shown in the accompanying drawings should be interpreted as illustrative and not in a limiting sense. Indeed many other embodiments are feasible and possible, as will be evident to one of ordinary skill in the art. The claims that follow are not limited by or to the embodiments discussed herein, but are limited solely by their terms and the Doctrine of Equivalents.

What is claimed:

1. A computer system having at least one physical processor and memory adapted by software instructions to determine without third-Party subjectivity, and visually indicate with a non-numeric graphic a gap in insurance coverage for a Party, comprising:
a Party Initializer module that collects from a Party, Party specific information, including, name, age, address and annual income;
a Risk Module that presents the Party with a first set of questions to collect information regarding Risk Evaluation and a second set of questions regarding Risk Tolerance, each question having a pre-determined set of optional answers each correlating to a different point value, the Risk Module determining a cumulative point value for the Party's indicated Risk Tolerance;
an Insurance Inventory Module permitting the Party to provide information regarding the nature and an amount of coverage for each type of insurance held by the Party;
an Asset Inventory Module permitting the Party to provide information regarding a nature and a value amount for each Asset provided in the Asset Inventory, the Asset Inventory further including a calculation of future income from the Party specific information of age and annual income;
a Processing module for comparative processing of the Insurance Inventory with the Asset Inventory to determine an initial gap value between the Party's initial insurance value and initial asset value; the Processing module further operating to receive a solution option for an additional type and amount of insurance selected by the Party and determine a solution value;
a Visualizer module for transforming the Party's Risk Tolerance, the gap value between the Party's initial insurance value and initial asset value, and the solution for insurance coverage into non-numeric graphics conceptualizing at least the Party's Risk Tolerance, the gap value between the Party's initial insurance value and initial asset value, and the solution for insurance coverage;
a database structured and arranged to record for each assessed Party, the Party specific information, Risk Evaluation answers, Risk Tolerance answers, Insurance Inventory, Asset Inventory, and determined gap valuations and solutions.

2. The computer system of claim 1, wherein the non-numeric graphics are pie charts.

3. The computer system of claim 1, wherein the Asset Inventory includes assets selected from the group consisting of, collecting bank account types and balances, investment account types and balances, personal property values, real estate value, and value of future income based on current age, current annual income and expected retirement age.

4. The computer system of claim 1, wherein the Insurance Inventory includes insurance selected from the group consisting of: auto insurance, home insurance, life insurance, disability insurance, collectables insurance, specialty insurance, and umbrella insurance

5. The computer system of claim 1, wherein the non-numeric visual graph conceptualizing the Party's gap in insurance coverage are for gaps in insurance selected from: auto liability, home owner liability, lifestyle of the Party, disability, and insured assets.

6. The computer system of claim 1, wherein the one or more solution options are selected from the group consisting of: auto liability insurance, home liability insurance, life insurance, and umbrella insurance.

7. The computer system of claim 1, wherein the non-numeric graphics permit the Party to assess representations of gap and solution in a non-numeric context.

8. The computer system of claim 1, wherein the computer system permits multiple instances of the software instructions to execute concurrently thereby permitting the system to determine without third-Party subjectivity, the gap in insurance coverage for a plurality of parties.

9. The computer system of claim 1, wherein the Party is a person, annual income being annual salary.

10. The computer system of claim 1, wherein the Party is an entity, age being the years in existence.

11. The computer system of claim 1, wherein upon the determination of a solution, an Insurance Agent presents the Party with at least one insurance policy corresponding to the solution.

12. A method to determine without third-Party subjectivity, and visually indicate with a non-numeric graphic a gap in insurance coverage for a Party, comprising:
receiving from the Party, Party specific information including, name, age, address and annual income;
presenting a set of Risk Evaluation questions to the Party and recording each Risk Evaluation answer as provided by the Party;
presenting a set of Risk Tolerance questions to the Party, each Risk Tolerance question providing a pre-defined set of answers, each answer corresponding to a pre-determined numeric value;
recording each Risk Tolerance answer and tallying the assigned values of each answer, and based on the aggregate value rendering an initial non-numeric graphic conceptualizing the Party's indicated risk level;
receiving from the Party an Insurance Inventory, including nature and an amount of coverage for each type of Insurance provided in the Insurance Inventory;
receiving from the Party an Asset Inventory, including a nature and a value amount for each Asset provided in the Asset Inventory, the Asset Inventory further including a calculation of future income from the Party specific information of age and annual income;
processing the Insurance Inventory and the Asset Inventory to determine an initial gap value between total initial insurance value and total initial asset value, and based on the initial gap valuation rendering at least one non-numeric graphic conceptualizing the Party's gap in insurance coverage; and
permitting the Party to select one or more solution options of different insurance types and amounts, and rendering at least one non-numeric graphic conceptualizing the Party's solution for insurance coverage for visual comparison with the Party's gap in insurance coverage, the initial gap and the solution determined directly from information provided by the Party and without third-Party subjectivity.

13. The method of claim 12, wherein rendering at least one non-numeric graphic transforms numerical data into a non-numeric graphic displayed to a user.

14. The method of claim 12, wherein the non-numeric graphics are pie charts.

15. The method of claim 12, wherein for each assessed Party, the Party specific information, Risk Evaluation answers, Risk Tolerance answers, Insurance Inventory, Asset Inventory, and determined gap valuations and solutions are recorded to a database.

16. The method of claim 12, wherein the Asset Inventory includes assets selected from the group consisting of: bank account types and balances, investment account types and balances, personal property values, real estate value, and value of future income based on current age, current annual income and expected retirement age.

17. The method of claim 12, wherein the Insurance Inventory includes insurance selected from the group consisting of: auto insurance, home insurance, life insurance, disability insurance, collectables insurance, specialty insurance, and umbrella insurance.

18. The method of claim 12, wherein the non-numeric visual graph conceptualizing the Party's gap in insurance coverage are for gaps in insurance selected from: auto liability, home owner liability, lifestyle of the Party, disability, and insured assets.

19. The method of claim 12, wherein the one or more solution options are selected from the group consisting of: auto liability insurance, home liability insurance, life insurance, and umbrella insurance.

20. The method of claim 12, wherein the non-numeric graphics permit the Party to assess representations of gap and solution in a non-numeric context.

21. The method of claim 12, wherein the Party is a person, annual income being annual salary.

22. The method of claim 12, wherein the Party is an entity, age being the years in existence.

23. The method of claim 12, wherein upon the determination of a solution, an Insurance Agent presents the Party with at least one insurance policy corresponding to the solution.

24. A non-transitory machine readable medium on which is stored a computer program for determining without third-Party subjectivity, and visually indicate with a non-numeric graphic a gap in insurance coverage for a Party, the computer program comprising instructions which when executed by a computer system having at least one processor performs the steps of:
receiving from the Party, Party specific information including, name, age, address and annual income;
presenting a set of Risk Evaluation questions to the Party and recording each Risk Evaluation answer as provided by the Party;
presenting a set of Risk Tolerance questions to the Party, each Risk Tolerance question providing a pre-defined set of answers, each answer corresponding to a pre-determined numeric value;
recording each Risk Tolerance answer and tallying the assigned values of each answer, and based on the aggregate value rendering an initial non-numeric graphic conceptualizing the Party's indicated risk level;
receiving from the Party an Insurance Inventory, including nature and an amount of coverage for each type of Insurance provided in the Insurance Inventory;
receiving from the Party an Asset Inventory, including a nature and a value amount for each Asset provided in the Asset Inventory, the Asset Inventory further including a calculation of future income from the Party specific information of age and annual income;
processing the Insurance Inventory and the Asset Inventory to determine an initial gap valuation between total initial insurance value and total initial asset value, and based on the initial gap valuation rendering at least one non-numeric graphic conceptualizing the Party's gap in insurance coverage; and
permitting the Party to select one or more solution options of different insurance types and amounts, and rendering at least one non-numeric graphic conceptualizing the Party's solution for insurance coverage for visual comparison with the Party's gap in insurance coverage, the initial gap and the solution determined directly from information provided by the user and without third-Party subjectivity.

25. The non-transitory machine readable medium of claim 24, wherein rendering at least one non-numeric graphic transforms numerical data into a non-numeric graphic displayed to a user.

26. The non-transitory machine readable medium of claim 24, wherein the non-numeric graphics are pie charts.

27. The non-transitory machine readable medium of claim 24, wherein for each assessed Party, the Party specific information, Risk Evaluation answers, Risk Tolerance answers, Insurance Inventory, Asset Inventory, and determined gap valuations and solutions are recorded to a database.

28. The non-transitory machine readable medium of claim 24, wherein the Asset Inventory includes assets selected from the group consisting of, collecting bank account types and balances, investment account types and balances, personal property values, real estate value, and value of future income based on current age, current annual income and expected retirement age.

29. The non-transitory machine readable medium of claim 24, wherein the Insurance Inventory includes insurance selected from the group consisting of: auto insurance, home insurance, life insurance, disability insurance, collectables insurance, specialty insurance, and umbrella insurance.

30. The non-transitory machine readable medium of claim 24, wherein the non-numeric visual graph conceptualizing the Party's gap in insurance coverage are for gaps in insurance selected from: auto liability, home owner liability, lifestyle of the Party, disability, and insured assets.

31. The non-transitory machine readable medium of claim 24, wherein the one or more solution options are selected from the group consisting of: auto liability insurance, home liability insurance, life insurance, and umbrella insurance.

32. The non-transitory machine readable medium of claim 24, wherein the non-numeric graphics permit the Party to assess representations of gap and solution in a non-numeric context.

33. The non-transitory machine readable medium of claim 24, wherein the Party is a person, annual income being annual salary.

34. The non-transitory machine readable medium of claim 24, wherein the Party is an entity, age being the years in existence.

35. The non-transitory machine readable medium of claim 24, wherein upon the determination of a solution, an Insurance Agent presents the Party with at least one insurance policy corresponding to the solution.

36. A method to determine without third-Party subjectivity, and visually indicate with a non-numeric graphic a gap in insurance coverage for a Party, comprising:
receiving from a Party a plurality of information items including, Party specific information, an indication of Risk Tolerance, an Insurance Inventory to determine a total initial insurance value and an Asset Inventory to determine a total initial asset value;
processing the received information items to determine Future Income for the Party and an initial gap value between total initial insurance value and total initial asset value, develop a non-numeric graphic representing Risk Tolerance;
developing non-numeric graphics conceptualizing the Party's Risk Tolerance and gap in insurance coverage;
permitting the Party to select one or more solution options of different insurance types and amounts, and rendering at least one non-numeric graphic conceptualizing the Party's solution for insurance coverage for visual comparison with the Party's gap in insurance coverage, the initial gap and the solution determined directly from information provided by the user and without third-Party subjectivity.

37. The method of claim 36, wherein rendering at least one non-numeric graphic transforms numerical data into a non-numeric graphic displayed to a user.

38. The method of claim 36, wherein the non-numeric graphics are pie charts.

39. The method of claim 36, wherein receiving the plurality of information items further includes:
receiving from the Party, Party specific information including, name, age, address and annual income;
presenting a set of Risk Evaluation questions to the Party and recording each Risk Evaluation answer as provided by the Party;
presenting a set of Risk Tolerance questions to the Party, each Risk Tolerance question providing a pre-defined set of answers, each answer corresponding to a pre-determined numeric value;
recording each Risk Tolerance answer and tallying the assigned values of each answer, and based on the aggregate value rendering an initial non-numeric graphic conceptualizing the Party's indicated risk level;
receiving from the Party an Insurance Inventory, including nature and an amount of coverage for each type of Insurance provided in the Insurance Inventory; and
receiving from the Party an Asset Inventory, including a nature and a value amount for each Asset provided in the Asset Inventory, the Asset Inventory further including a calculation of future income from the Party specific information of age and annual income.

40. The method of claim 36, wherein the Asset Inventory includes assets selected from the group consisting of, collecting bank account types and balances, investment account types and balances, personal property values, real estate value, and value of future income based on current age, current annual income and expected retirement age.

41. The method of claim 36, wherein the Insurance Inventory includes insurance selected from the group consisting of: auto insurance, home insurance, life insurance, disability insurance, collectables insurance, specialty insurance, and umbrella insurance.

42. The method of claim 36, wherein the non-numeric visual graph conceptualizing the Party's gap in insurance coverage are for gaps in insurance selected from: auto liability, home owner liability, lifestyle of the Party, disability, and insured assets.

43. The method of claim 36, wherein the one or more solution options are selected from the group consisting of: auto liability insurance, home liability insurance, life insurance, and umbrella insurance.

44. The method of claim 36, wherein the non-numeric graphics permit the Party to assess representations of gap and solution in a non-numeric context.

45. The method of claim 36, wherein the Party is a person, annual income being annual salary.

46. The method of claim 36, wherein the Party is an entity, age being the years in existence.
